(19) United States
(12) Patent Application Publication
(10) Pub. No.: US 2018/0322536 A1
(43) Pub. Date: Nov. 8, 2018

(54) RESOURCE UTILIZATION BASED CROSS DEVICE TRANSMISSIONS

(71) Applicant: Google Inc., Mountain View, CA (US)

(72) Inventors: Guannan Zhang, Shanghai (CH); Kai Ye, Santa Clara, CA (US); Gaurav Bhaya, Sunnyvale, CA (US); Robert Stets, Mountain View, CA (US)

(73) Assignee: Google Inc., Mountain View, CA (US)

(21) Appl. No.: 15/638,291

(22) Filed: Jun. 29, 2017

Related U.S. Application Data
(63) Continuation-in-part of application No. 14/172,353, filed on Feb. 4, 2014.
Application No. 14/172,353 is a continuation of application No. 14/155,323, filed on Jan. 14, 2014, now abandoned.
Application No. 14/155,323 is a continuation-in-part of application No. 15/395,703, filed on Dec. 30, 2016, now Pat. No. 10,032,452.

(51) Int. Cl. G06Q 30/02

(52) U.S. Cl. CPC G06Q 30/0276; G06Q 30/0277

(57) ABSTRACT

A system and method for generating content having an embedded optical label includes serving the ad, logging engagement, and transmitting a platform-specific redirect link. A third-party content provider specifies a URL to a webpage. A content generator uses the URL to generate content including an optical label encoding a combined URL. The combined URL includes a click server URL and redirect links from the webpage. Content is generated with various elements from the webpage and served to a first client device. When a second client device scans the optical label, the second client device decodes the optical label and sends a request to a click server. The click server logs user engagement, detects the platform of the second client device, and transmits a redirect link to the second client device.

### CROSS-RELATED APPLICATION

The present application claims the benefit of priority under 35 U.S.C. § 120 as a continuation-in-part of U.S. patent application Ser. No. 14/172,353, filed Feb. 4, 2014, which claims the benefit of priority under 35 U.S.C. § 120 as a continuation of U.S. patent application Ser. No. 14/155,323, filed Jan. 14, 2014. The present application also claims the benefit of priority under 35 U.S.C. § 120 as a continuation-in-part of U.S. patent application Ser. No. 15/395,703, filed Dec. 30, 2016. Each of the foregoing applications is hereby incorporated by reference in their entirety.

### BACKGROUND

Excessive network transmissions, packet-based or otherwise, of network traffic data between computing devices can prevent a computing device from properly processing the network traffic data, completing an operation related to the network traffic data, or timely responding to the network traffic data. The excessive network transmissions of network traffic data can also complicate data routing or degrade the quality of the response if the responding computing device is at or above its processing capacity, which may result in inefficient bandwidth utilization. The control of network transmissions corresponding to content item objects can be complicated by the large number of content item objects that can initiate network transmissions of network traffic data between computing devices. Additionally, computing devices may not have the computational resources to render or process different types of content items.

### SUMMARY

At least one aspect of the disclosure is directed to a system to complete requests with multiple networked devices. The system includes a data processing system to receive a first request for content from a first computing device. The system includes a data processing system to transmit a digital component to the first computing device to fulfill the first request. The digital component can include a label and audio-based content. The label can encode a uniform resource locator. The data processing system can receive a second request from a second computing device. The second request can include the uniform resource locator. The second request can be generated responsive to the second computing device decoding the label. The data processing system can determine a set of resources associated with the second computing device. The data processing system can select a second digital component based on the uniform resource locator and the set of resources. The data processing system can transmit the second digital component to the second computing device.

At least one aspect of the disclosure is directed to a method to complete requests with multiple networked devices. The method can include receiving, by a data processing system, a first request for content from a first computing device. The method can include transmitting, by the data processing system, a digital component to the first computing device to fulfill the first request. The digital component can include a label and audio-based content. The label can encode a uniform resource locator. The method can include receiving, by the data processing system, a second request from a second computing device. The second request can include the uniform resource locator. The second request can be generated responsive to the second computing device decoding the label. The method can include determining, by the data processing system, a set of resources associated with the second computing device. The method can include selecting, by the data processing system, a second digital component based on the uniform resource locator and the set of resources. The method can include transmitting, by the data processing system, the second digital component to the second computing device.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1A is an overview depicting an implementation of a system of providing information via a computer network.

FIG. 1B depicts a system to of multi-modal transmission of packetized data in a voice activated computer network environment.

FIG. 1C depicts a flow diagram for multi-modal transmission of packetized data in a voice activated computer network environment.

FIG. 2 is a flowchart of one implementation of a method for content generation.

FIG. 3A is a schematic diagram of one implementation of a content generation system.

FIG. 3B is a schematic diagram of one implementation of a content generation system that includes a receiver.

FIG. 4A depicts one implementation of a webpage referenced by a URL specified by a third-party content provider.

FIG. 4B depicts one implementation of generated content corresponding to the webpage depicted in FIG. 4A.

FIG. 5 is a flowchart of one embodiment of a method for serving content, logging user engagement, and transmitting a platform-specific redirect link.

FIG. 6 is a diagram of one embodiment of a system for serving content, logging user engagement and transmitting a platform-specific redirect link.

FIG. 7 illustrates a block diagram of an example method to complete network requests with multiple devices.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for multi-modal transmission of packetized data in a voice activated data packet based computer network environment. The various concepts introduced above and discussed in greater detail below may be implemented in any of numerous ways.

Systems and methods of the present disclosure relate generally to a data processing system that identifies an optimal transmission modality for data packet (or other protocol based) transmission in a voice activated computer network environment. The data processing system can improve the efficiency and effectiveness of data packet transmission over one or more computer networks by, for example, selecting a transmission modality from a plurality of options for data packet routing through a computer network of content items to one or more client computing device, or to different interfaces (e.g., different apps or programs) of a single client computing device. Content items can also be referred to as digital components. In some implementations, a digital component can be a component of a content item. Data packets or other protocol based signals corresponding to the selected operations can be routed through a computer network between multiple computing devices. For example the data processing system can route a content item to a different interface than an interface from which a request was received. The different interface can be on the same client computing device or a different client computing device from which a request was received. The data processing system can select at least one candidate interface from a plurality of candidate interfaces for content item transmission to a client computing device. The candidate interfaces can be determined based on technical or computing parameters such as processor capability or utilization rate, memory capability or availability, battery status, available power, network bandwidth utilization, interface parameters or other resource utilization values. By selecting an interface to receive and provide the content item for rendering from the client computing device based on candidate interfaces or utilization rates associated with the candidate interfaces, the data processing system can reduce network bandwidth usage, latency, or processing utilization or power consumption of the client computing device that renders the content item. This saves processing power and other computing resources such as memory, reduces electrical power consumption by the data processing system and the reduced data transmissions via the computer network reduces bandwidth requirements and usage of the data processing system.

The systems and methods described herein can include a data processing system that receives an input audio query, which can also be referred to as an input audio signal. From the input audio query the data processing system can identify a request and a trigger keyword corresponding to the request. Based on the trigger keyword or the request, the data processing system can generate a first action data structure. For example, the first action data structure can include an organic response to the input audio query received from a client computing device, and the data processing system can provide the first action data structure to the same client computing device for rendering as audio output via the same interface from which the request was received.

The data processing system can also select at least one content item based on the trigger keyword or the request. The data processing system can identify or determine a plurality of candidate interfaces for rendering of the content item(s). The interfaces can include one or more hardware or software interfaces, such as display screens, audio interfaces, speakers, applications or programs available on the client computing device that originated the input audio query, or on different client computing devices. The interfaces can include java script slots for online documents for the insertion of content items, as well as push notification interfaces. The data processing system can determine utilization values for the different candidate interfaces. The utilization values can indicate power, processing, memory, bandwidth, or interface parameter capabilities, for example. Based on the utilization values for the candidate interfaces the data processing system can select a candidate interface as a selected interface for presentation or rendering of the content item. For example, the data processing system can convert or provide the content item for delivery in a modality compatible with the selected interface. The selected interface can be an interface of the same client computing device that originated the input audio signal or a different client computing device. By routing data packets via a computing network based on utilization values associated with a candidate interface, the data processing system selects a destination for the content item in a manner that can use the least amount of processing power, memory, or bandwidth from available options, or that can conserve power of one or more client computing devices.

The data processing system can provide the content item or the first action data structure by packet or other protocol based data message transmission via a computer network to a client computing device. The output signal can cause an audio driver component of the client computing device to generate an acoustic wave, e.g., an audio output, which can be output from the client computing device. The audio (or other) output can correspond to the first action data structure or to the content item. For example the first action data structure can be routed as audio output, and the content item can be routed as a text based message. By routing the first action data structure and the content item to different interfaces, the data processing system can conserve resources utilized by each interface, relative to providing both the first action data structure and the content item to the same interface. This results in fewer data processing operations, less memory usage, or less network bandwidth utilization by the selected interfaces (or their corresponding devices) than would be the case without separation and independent routing of the first action data structure and the content item.

In a networked environment, such as the Internet or other networks, first-party content providers can provide information for public presentation on resources, for example webpages, documents, applications, and/or other resources. The first-party content can include text, video, and/or audio information provided by the first-party content providers via, for example, a resource server for presentation on a client device over the Internet. The first-party content may be a webpage requested by the client device or a stand-alone application (e.g., a video game, a chat program, etc.) running on the client device. Additional third-party content can also be provided by third-party content providers for presentation on the client device together with the first-party content provided by the first-party content providers. For example, the third-party content may be a public service announcement or digital component that appears in conjunction with a requested resource, such as a webpage (e.g., a search result webpage from a search engine, a webpage that includes an online article, a webpage of a social networking service, etc.) or with an application (e.g., an digital component within a game). Thus, a person viewing a resource can access the first-party content that is the subject of the resource as well as the third-party content that may or may not be related to the subject matter of the resource.

A computing device (e.g., a client device) can view a resource, such as a webpage, a document, an application, etc. In some implementations, the computing device may access the resource via the Internet by communicating with a server, such as a webpage server, corresponding to that resource. The resource includes first-party content that is the subject of the resource from a first-party content provider and may also include additional third-party provided content, such as digital components or other content. In one implementation, responsive to receiving a request to access a webpage, a webpage server and/or a client device can communicate with a data processing system, such as a content item selection system, to request a content item to be presented with the requested webpage, such as through the execution of code of the resource to request a third-party content item to be presented with the resource. The content item selection system can select a third-party content item and provide data to effect presentation of the content item with the requested webpage on a display of the client device. In some instances, the content item is selected and served with a resource associated with a search query response. For example, a search engine may return search results on a search results webpage and may include third-party content items related to the search query in one or more content item slots of the search results webpage.

The computing device (e.g., a client device) may also be used to view or execute an application, such as a mobile application. The application may include first-party content that is the subject of the application from a first-party content provider and may also include additional third-party provided content, such as digital components or other content. In one implementation, responsive to use of the application, a resource server and/or a client device can communicate with a data processing system, such as a content item selection system, to request a content item to be presented with a user interface of the application and/or otherwise. The content item selection system can select a third-party content item and provide data to effect presentation of the content item with the application on a display of the client device.

In some instances, a device identifier may be associated with the client device. The device identifier may be a randomized number associated with the client device to identify the device during subsequent requests for resources and/or content items. In some instances, the device identifier may be configured to store and/or cause the client device to transmit information related to the client device to the content item selection system and/or resource server (e.g., values of sensor data, a web browser type, an operating system, historical resource requests, historical content item requests, etc.).

In some instances, when the content item is displayed on a first client device, a second client device may be used to optically capture parts of the presented third-party content item. The second client device may include a camera. The presented third-party provided content may include labels that may be scanned on the second client device via the camera. The labels may encode a URL. The second client device may decode the URL and navigate to the webpage referenced by the URL via a network.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

In some implementations, third-party content may be a digital component or an offer. The third-party content may reference a webpage that may be opened when a client clicks on or interacts with the third-party content. The third-party content may contain multiple links or labels that encode links. The links may reference a webpage to a download page of an application (e.g. a mobile app). The links may also reference mobile apps of different mobile platforms.

A third party content provider may utilize an automatic content generator to generate the third-party content. The third-party content provider may provide the automatic content generator with a URL. The automatic content generator may retrieve various elements from the webpage referenced by the URL. In one instance, the automatic content generator may create a third-party content item with an embedded label. The label may be encoded with a URL to a click server that is part of content item management service.

A third-party content provider, when providing third-party content items for presentation with requested resources via the Internet or other network, may utilize a content item management service to control or otherwise influence the selection and serving of the third-party content items. For instance, a third-party content provider may specify selection criteria (such as keywords) and corresponding bid values that are used in the selection of the third-party content items. The bid values may be utilized by the content item selection system in an auction to select and serve content items for presentation with a resource. For example, a third-party content provider may place a bid in the auction that corresponds to an agreement to pay a certain amount of money if a user interacts with the provider's content item (e.g., the provider agrees to pay $3 if a user clicks on the provider's content item). In other examples, a third-party content provider may place a bid in the auction that corresponds to an agreement to pay a certain amount of money if the content item is selected and served (e.g., the provider agrees to pay $0.005 each time a content item is selected and served or the provider agrees to pay $0.05 each time a content item is selected or clicked). In some instances, the content item selection system uses content item interaction data to determine the performance of the third-party content provider's content items. For example, users may be more inclined to click on third-party content items on certain webpages over others. Accordingly, auction bids to place the third-party content items may be higher for high-performing webpages, categories of webpages, and/or other criteria, while the bids may be lower for low-performing webpages, categories of webpages, and/or other criteria.

In some instances, one or more performance metrics for the third-party content items may be determined and indications of such performance metrics may be provided to the third-party content provider via a user interface for the content item management account. For example, the performance metrics may include a cost per impression (CPI) or cost per thousand impressions (CPM), where an impression may be counted, for example, whenever a content item is selected to be served for presentation with a resource. In some instances, the performance metric may include a click-through rate (CTR), defined as the number of clicks on the content item divided by the number of impressions. In some instances, the performance metrics may include a cost per engagement (CPE), where an engagement may be counted when a user interacts with the content item in a specified way. Examples of engagement include sharing a link to the content item on a social networking site, submitting an email address, taking a survey, and watching a video to completion. Still other performance metrics, such as cost per action (CPA) (where an action may be clicking on the content item or a link therein, a purchase of a product, a referral of the content item, etc.), conversion rate (CVR), cost per click-through (CPC) (counted when a content item is clicked), cost per sale (CPS), cost per lead (CPL), effective CPM (eCPM), and/or other performance metrics may be used. The various performance metrics may be measured before, during, or after content selection, content presentation, user click, or user engagement. In one instance, user click and user engagement may be measured by a click server that may be part of the content item management service.

In some instances, a webpage or other resource (such as, for example, an application) includes one or more content item slots in which a selected and served third-party content item may be displayed. The code (e.g., JavaScript®, HTML, etc.) defining a content item slot for a webpage or other resource may include instructions to request a third-party content item from the content item selection system to be presented with the webpage. In some implementations, the code may include an image request having a content item request URL that may include one or more parameters (e.g., /page/contentitem?devid=abc123&devnfo=A34r0). Such parameters may, in some implementations, be encoded strings such as “devid=abc123” and/or “devnfo=A34r0.”

The selection of a third-party content item to be served with the resource by a content item selection system may be based on several influencing factors, such as a predicted click through rate (pCTR), a predicted conversion rate (pCVR), and a bid associated with the content item, etc. Such influencing factors may be used to generate a value, such as a score, against which other scores for other content items may be compared by the content item selection system through an auction.

During an auction for a content item slot for a resource, such as a webpage, several different types of bid values may be utilized by third-party content providers for various third-party content items. For example, an auction may include bids based on whether a user clicks on the third-party content item, whether a user performs a specific action based on the presentation of the third-party content item, whether the third-party content item is selected and served, and/or other types of bids. For example, a bid based on whether the third-party content item is selected and served may be a lower bid (e.g., $0.005) while a bid based on whether a user performs a specific action may be a higher bid (e.g., $5). In some instances, the bid may be adjusted to account for a probability associated with the type of bid and/or adjusted for other reasons. For example, the probability of the user performing the specific action may be low, such as 0.2%, while the probability of the selected and served third-party content item may be 100% (e.g., the selected and served content item will occur if it is selected during the auction, so the bid is unadjusted). Accordingly, a value, such as a score or a normalized value, may be generated to be used in the auction based on the bid value and the probability or another modifying value. In the prior example, the value or score for a bid based on whether the third-party content item is selected and served may be $0.005*1.00=0.005 and the value or score for a bid based on whether a user performs a specific action may be $5*0.002=0.01. To maximize the income generated, the content item selection system may select the third-party content item with the highest value from the auction. In the foregoing example, the content item selection system may select the content item associated with the bid based on whether the user performs the specific action due to the higher value or score associated with that bid.

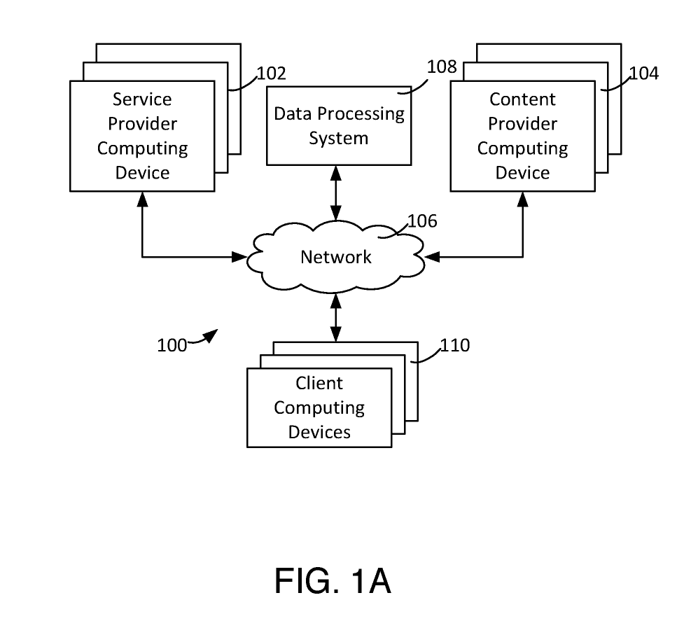

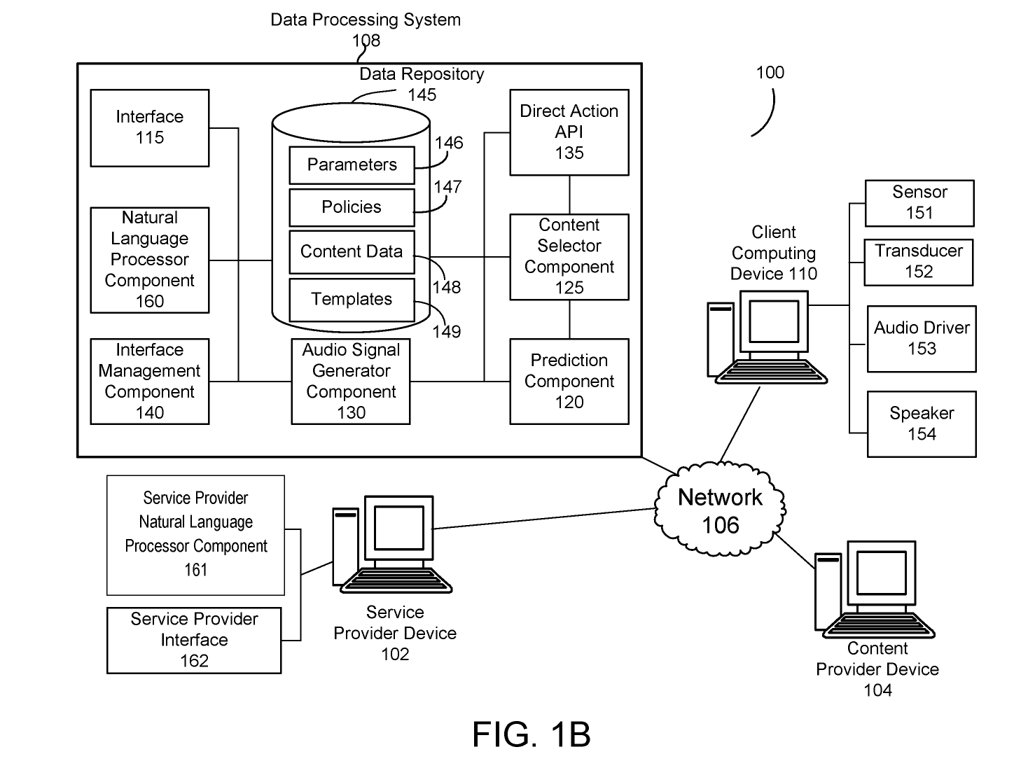

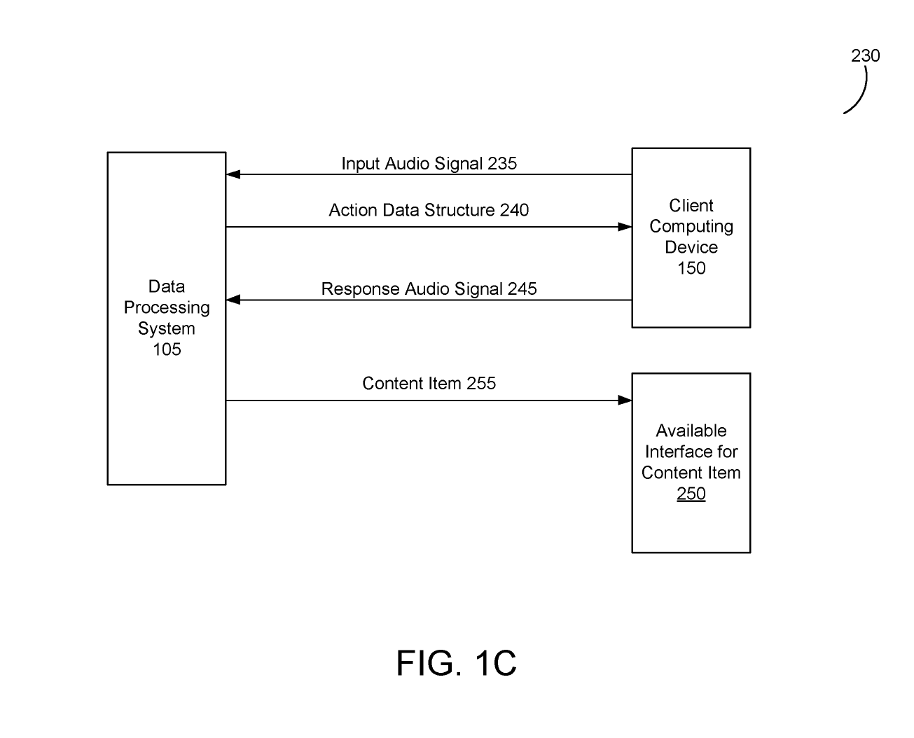

FIG. 1A is a block diagram of an implementation of a system 100 for providing information via at least one computer network such as the network 106. The network 106 may include a local area network (LAN), wide area network (WAN), a telephone network, such as the Public Switched Telephone Network (PSTN), a wireless link, an intranet, the Internet, or combinations thereof. The system 100 can also include at least one data processing system, which can include a content item selection system. The data processing system 108 can include at least one logic device, such as a computing device having a data processor, to communicate via the network 106, for example with a content provider computing device 104, a client computing device 110, and/or a service provider computing device 102. The data processing system 108 can include one or more data processors, such as a content placement processor, configured to execute instructions stored in a memory device to perform one or more operations described herein. In other words, the one or more data processors and the memory device of the data processing system 108 may form a processing module. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, C, C++, C#, Java®, JavaScript®, Perl®, HTML, XML, Python®, and Visual Basic®. The processor may process instructions and output data to effect presentation of one or more content items to the content provider computing device 104 and/or the client computing device 110. In addition to the processing circuit, the data processing system 108 may include one or more databases configured to store data. The data processing system 108 may also include an interface configured to receive data via the network 106 and to provide data from the data processing system 108 to any of the other devices on the network 106. The data processing system 108 can include a server, such as an digital component server or otherwise.

The client computing device 110 can include one or more devices such as a computer, laptop, desktop, smart phone, wearable device, smart watch, tablet, personal digital assistant, set-top box for a television set, smart television, or server device configured to communicate with other devices via the network 106. The device may be any form of portable electronic device that includes a data processor and a memory. The memory may store machine instructions that, when executed by a processor, cause the processor to perform one or more of the operations described herein. The memory may also store data to effect presentation of one or more resources, content items, etc. on the computing device. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, HTML, Java®, JavaScript®, Perl®, Python®, Visual Basic®, and XML.

The client computing device 110 can execute a software application (e.g., a web browser or other application) to retrieve content from other computing devices over network 106. Such an application may be configured to retrieve first-party content from a content provider computing device 104. In some cases, an application running on the client computing device 110 may itself be first-party content (e.g., a game, a media player, etc.). In one implementation, the client computing device 110 may execute a web browser application which provides a browser window on a display of the client device. The web browser application that provides the browser window may operate by receiving input of a uniform resource locator (URL), such as a web address, from an input device (e.g., a pointing device, a keyboard, a touch screen, or another form of input device). In response, one or more processors of the client device executing the instructions from the web browser application may request data from another device connected to the network 106 referred to by the URL address (e.g., a content provider computing device 104). The other device may then provide web page data and/or other data to the client computing device 110, which causes visual indicia to be displayed by the display of the client computing device 110. Accordingly, the browser window displays the retrieved first-party content, such as web pages from various websites, to facilitate user interaction with the first-party content.

The content provider computing device 104 can include a computing device, such as a server, configured to host a resource, such as a web page or other resource (e.g., articles, comment threads, music, video, graphics, search results, information feeds, etc.). The content provider computing device 104 may be a computer server (e.g., a file transfer protocol (FTP) server, file sharing server, web server, etc.) or a combination of servers (e.g., a data center, a cloud computing platform, etc.). The content provider computing device 104 can provide resource data or other content (e.g., text documents, PDF files, and other forms of electronic documents) to the client computing device 110. In one implementation, the client computing device 110 can access the content provider computing device 104 via the network 106 to request data to effect presentation of a resource of the content provider computing device 104.

One or more third-party content providers may have service provider computing devices 102 to directly or indirectly provide data for third-party content items to the data processing system 108 and/or to other computing devices via network 106. The content items may be in any format that may be presented on a display of a client computing device 110, for example, graphical, text, image, audio, video, etc. The content items may also be a combination (hybrid) of the formats. The content items may be banner content items, interstitial content items, pop-up content items, rich media content items, hybrid content items, Flash® content items, cross-domain iframe content items, etc. The content items may also include embedded information such as hyperlinks, metadata, links, machine-executable instructions, annotations, etc. In some instances, the service provider computing devices 102 may be integrated into the data processing system 108 and/or the data for the third-party content items may be stored in a database of the data processing system 108.

In one implementation, the data processing system 108 can receive, via the network 106, a request for a content item to present with a resource. The received request may be received from a content provider computing device 104, a client computing device 110, and/or any other computing device. The content provider computing device 104 may be owned or ran by a first-party content provider that may include instructions for the data processing system 108 to provide third-party content items with one or more resources of the first-party content provider on the content provider computing device 104. In one implementation, the resource may include a web page. The client computing device 110 may be a computing device operated by a user (represented by a device identifier), which, when accessing a resource of the content provider computing device 104, can make a request to the data processing system 108 for content items to be presented with the resource, for instance. The content item request can include requesting device information (e.g., a web browser type, an operating system type, one or more previous resource requests from the requesting device, one or more previous content items received by the requesting device, a language setting for the requesting device, a geographical location of the requesting device, a time of a day at the requesting device, a day of a week at the requesting device, a day of a month at the requesting device, a day of a year at the requesting device, etc.) and resource information (e.g., URL of the requested resource, one or more keywords of the content of the requested resource, text of the content of the resource, a title of the resource, a category of the resource, a type of the resource, etc.). The information that the data processing system 108 receives can include a HyperText Transfer Protocol (HTTP) cookie which contains a device identifier (e.g., a random number) that represents the client computing device 110. In some implementations, the device information and/or the resource information may be appended to a content item request URL (e.g., contentitem.item/page/contentitem?devid=abc123&devnfo=A34r0). In some implementations, the device information and/or the resource information may be encoded prior to being appended the content item request URL. The requesting device information and/or the resource information may be utilized by the data processing system 108 to select third-party content items to be served with the requested resource and presented on a display of a client computing device 110.

In some instances, a resource of a content provider computing device 104 may include a search engine feature. The search engine feature may receive a search query (e.g., a string of text) via an input feature (an input text box, etc.). The search engine may search an index of documents (e.g., other resources, such as web pages, etc.) for relevant search results based on the search query. The search results may be transmitted as a second resource to present the relevant search results, such as a search result web page, on a display of a client computing device 110. The search results may include web page titles, hyperlinks, etc. One or more third-party content items may also be presented with the search results in a content item slot of the search result web page. Accordingly, the content provider computing device 104 and/or the client computing device 110 may request one or more content items from the data processing system 108 to be presented in the content item slot of the search result web page. The content item request may include additional information, such as the user device information, the resource information, a quantity of content items, a format for the content items, the search query string, keywords of the search query string, information related to the query (e.g., geographic location information and/or temporal information), etc. In some implementations, delineation may be made between the search results and the third-party content items to avert confusion.

In some implementations, the third-party content provider may manage the selection and serving of content items by data processing system 108. For example, the third-party content provider may set bid values and/or selection criteria via a user interface that may include one or more content item conditions or constraints regarding the serving of content items. A third-party content provider may specify that a content item and/or a set of content items should be selected and served for client computing devices 110 having device identifiers associated with a certain geographic location or region, a certain language, a certain operating system, a certain web browser, etc. In another implementation, the third-party content provider may specify that a content item or set of content items should be selected and served when the resource, such as a web page, document, etc., contains content that matches or is related to certain keywords, phrases, etc. The third-party content provider may set a single bid value for several content items, set bid values for subsets of content items, and/or set bid values for each content item. The third-party content provider may also set the types of bid values, such as bids based on whether a user clicks on the third-party content item, whether a user performs a specific action based on the presentation of the third-party content item, whether the third-party content item is selected and served, and/or other types of bids.

FIG. 1B depicts an example system 100 to for multi-modal transmission of packetized data in a voice activated data packet (or other protocol) based computer network environment. The system 100 can include at least one data processing system 108, which can also be referred to or include a data processing system. The data processing system 108 can include at least one server having at least one processor. For example, the data processing system 108 can include a plurality of servers located in at least one data center or server farm. The data processing system 108 can determine, from an audio input signal a request and a trigger keyword associated with the request. Based on the request and trigger keyword the data processing system 108 can determine or select at least one action data structure, and can select at least one content item (and initiate other actions as described herein). The data processing system 108 can identify candidate interfaces for rendering of the action data structures or the content items, and can provide the action data structures or the content items for rendering by one or more candidate interfaces on one or more client computing devices based on resource utilization values for or of the candidate interfaces, for example as part of a voice activated communication or planning system. The action data structures (or the content items) can include one or more audio files that when rendered provide an audio output or acoustic wave. The action data structures or the content items can include other content (e.g., text, video, or image content) in addition to audio content.

The data processing system 108 can include multiple, logically-grouped servers and facilitate distributed computing techniques. The logical group of servers may be referred to as a data center, server farm or a machine farm. The servers can be geographically dispersed. A data center or machine farm may be administered as a single entity, or the machine farm can include a plurality of machine farms. The servers within each machine farm can be heterogeneous—one or more of the servers or machines can operate according to one or more type of operating system platform. The data processing system 108 can include servers in a data center that are stored in one or more high-density rack systems, along with associated storage systems, located for example in an enterprise data center. The data processing system 108 with consolidated servers in this way can improve system manageability, data security, the physical security of the system, and system performance by locating servers and high performance storage systems on localized high performance networks. Centralization of all or some of the data processing system 108 components, including servers and storage systems, and coupling them with advanced system management tools allows more efficient use of server resources, which saves power and processing requirements and reduces bandwidth usage.

The data processing system 108 can include at least one natural language processor (NLP) component 160, at least one interface 115, at least one prediction component 120, at least one content selector component 125, at least one audio signal generator component 130, at least one direct action application programming interface (API) 135, at least one interface management component 140, and at least one data repository 145. The NLP component 160, interface 115, prediction component 120, content selector component 125, audio signal generator component 130, direct action API 135, and interface management component 140 can each include at least one processing unit, server, virtual server, circuit, engine, agent, appliance, or other logic device such as programmable logic arrays configured to communicate with the data repository 145 and with other computing devices (e.g., at least one client computing device 110, at least one content provider computing device 104, or at least one service provider computing device 102) via the at least one computer network 106. The network 106 can include computer networks such as the internet, local, wide, metro or other area networks, intranets, satellite networks, other computer networks such as voice or data mobile phone communication networks, and combinations thereof.

The network 106 can include or constitute a display network, e.g., a subset of information resources available on the internet that are associated with a content placement or search engine results system, or that are eligible to include third party content items as part of a content item placement campaign. The network 106 can be used by the data processing system 108 to access information resources such as web pages, web sites, domain names, or uniform resource locators that can be presented, output, rendered, or displayed by the client computing device 110. For example, via the network 106 a user of the client computing device 110 can access information or data provided by the data processing system 108, the content provider computing device 104 or the service provider computing device 102.

The network 106 can include, for example a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network or a wireline network, and combinations thereof. The network 106 can include a wireless link, such as an infrared channel or satellite band. The topology of the network 106 may include a bus, star, or ring network topology. The network 106 can include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The client computing device 110, the content provider computing device 104, and the service provider computing device 102 can each include at least one logic device such as a computing device having a processor to communicate with each other or with the data processing system 108 via the network 106. The client computing device 110, the content provider computing device 104, and the service provider computing device 102 can each include at least one server, processor or memory, or a plurality of computation resources or servers located in at least one data center. The client computing device 110, the content provider computing device 104, and the service provider computing device 102 can each include at least one computing device such as a desktop computer, laptop, tablet, personal digital assistant, smartphone, portable computer, server, thin client computer, virtual server, or other computing device.

The client computing device 110 can include at least one sensor 151, at least one transducer 152, at least one audio driver 153, and at least one speaker 154. The sensor 151 can include a microphone, audio input sensor, or camera. The transducer 152 can convert the audio input into an electronic signal, or vice-versa. The audio driver 153 can include a script or program executed by one or more processors of the client computing device 110 to control the sensor 151, the transducer 152 or the audio driver 153, among other components of the client computing device 110 to process audio input or provide audio output. The speaker 154 can transmit the audio output signal.

The client computing device 110 can be associated with an end user that enters voice queries as audio input into the client computing device 110 (via the sensor 151) and receives audio output in the form of a computer generated voice that can be provided from the data processing system 108 (or the content provider computing device 104 or the service provider computing device 102) to the client computing device 110, output from the speaker 154. The audio output can correspond to an action data structure received from the direct action API 135, or a content item selected by the content selector component 125. The computer generated voice can include recordings from a real person or computer generated language.

The content provider computing device 104 (or the data processing system 108 or service provider computing device 102) can provide audio based content items or action data structures for display by the client computing device 110 as an audio output. The action data structure or content item can include an organic response or offer for a good or service, such as a voice based message that states: “Today it will be sunny and 80 degrees at the beach” as an organic response to a voice-input query of “Is today a beach day?”. The data processing system 108 (or other system 100 component such as the content provider computing device 104 can also provide a content item as a response, such as a voice or text message based content item offering sunscreen.

The content provider computing device 104 or the data repository 145 can include memory to store a series of audio action data structures or content items that can be provided in response to a voice based query. The action data structures and content items can include packet based data structures for transmission via the network 106. The content provider computing device 104 can also provide audio or text based content items (or other content items) to the data processing system 108 where they can be stored in the data repository 145. The data processing system 108 can select the audio action data structures or text based content items and provide (or instruct the content provider computing device 104 to provide) them to the same or different client computing devices 110 responsive to a query received from one of those client computing device 110. The audio based action data structures can be exclusively audio or can be combined with text, image, or video data. The content items can be exclusively text or can be combined with audio, image or video data.

The service provider computing device 102 can include at least one service provider natural language processor (NLP) component 161 and at least one service provider interface 162. The service provider NLP component 161 (or other components such as a direct action API of the service provider computing device 102) can engage with the client computing device 110 (via the data processing system 108 or bypassing the data processing system 108) to create a back-and-forth real-time voice or audio based conversation (e.g., a session) between the client computing device 110 and the service provider computing device 102. For example, the service provider interface 162 can receive or provide data messages (e.g., action data structures or content items) to the direct action API 135 of the data processing system 108. The direct action API 135 can also generate the action data structures independent from or without input from the service provider computing device 102. The service provider computing device 102 and the content provider computing device 104 can be associated with the same entity. For example, the content provider computing device 104 can create, store, or make available content items for beach relates services, such as sunscreen, beach towels or bathing suits, and the service provider computing device 102 can establish a session with the client computing device 110 to respond to a voice input query about the weather at the beach, directions for a beach, or a recommendation for an area beach, and can provide these content items to the end user of the client computing device 110 via an interface of the same client computing device 110 from which the query was received, a different interface of the same client computing device 110, or an interface of a different client computing device. The data processing system 108, via the direct action API 135, the NLP component 160 or other components can also establish the session with the client computing device, including or bypassing the service provider computing device 102, to for example to provide an organic response to a query related to the beach.

The data repository 145 can include one or more local or distributed databases, and can include a database management system. The data repository 145 can include computer data storage or memory and can store one or more parameters 146, one or more policies 147, content data 148, or templates 149 among other data. The parameters 146, policies 147, and templates 149 can include information such as rules about a voice based session between the client computing device 110 and the data processing system 108 (or the service provider computing device 102). The content data 148 can include content items for audio output or associated metadata, as well as input audio messages that can be part of one or more communication sessions with the client computing device 110.

The system 100 can optimize processing of action data structures and content items in a voice activated data packet (or other protocol) environment. For example, the data processing system 108 can include or be part of a voice activated assistant service, voice command device, intelligent personal assistant, knowledge navigator, event planning, or other assistant program. The data processing system 108 can provide one or more instances of action data structures as audio output for display from the client computing device 110 to accomplish tasks related to an input audio signal. For example, the data processing system can communicate with the service provider computing device 102 or other third party computing devices to generate action data structures with information about a beach, among other things. For example, an end user can enter an input audio signal into the client computing device 110 of: “OK, I would like to go to the beach this weekend” and an action data structure can indicate the weekend weather forecast for area beaches, such as “it will be sunny and 80 degrees at the beach on Saturday, with high tide at 3 pm.”

The action data structures can include a number of organic or non-sponsored responses to the input audio signal. For example, the action data structures can include a beach weather forecast or directions to a beach. The action data structures in this example include organic, or non-sponsored content that is directly responsive to the input audio signal. The content items responsive to the input audio signal can include sponsored or non-organic content, such as an offer to buy sunscreen from a convenience store located near the beach. In this example, the organic action data structure (beach forecast) is responsive to the input audio signal (a query related to the beach), and the content item (a reminder or offer for sunscreen) is also responsive to the same input audio signal. The data processing system 108 can evaluate system 100 parameters (e.g., power usage, available displays, formats of displays, memory requirements, bandwidth usage, power capacity or time of input power (e.g., internal battery or external power source such as a power source from a wall output) to provide the action data structure and the content item to different candidate interfaces on the same client computing device 110, or to different candidate interfaces on different client computing devices 110.

The data processing system 108 can include an application, script or program installed at the client computing device 110, such as an app to communicate input audio signals (e.g., as data packets via a packetized or other protocol based transmission) to at least one interface 115 of the data processing system 108 and to drive components of the client computing device 110 to render output audio signals (e.g., for action data structures) or other output signals (e.g., content items). The data processing system 108 can receive data packets or other signal that includes or identifies an audio input signal. For example, the data processing system 108 can execute or run the NLP component 160 to receive the audio input signal.

The NLP component 160 can convert the audio input signal into recognized text by comparing the input signal against a stored, representative set of audio waveforms (e.g., in the data repository 145) and choosing the closest matches. The representative waveforms are generated across a large set of users, and can be augmented with speech samples. After the audio signal is converted into recognized text, the NLP component 160 can match the text to words that are associated, for example via training across users or through manual specification, with actions that the data processing system 108 can serve.

The audio input signal can be detected by the sensor 151 (e.g., a microphone) of the client computing device. Via the transducer 152, the audio driver 153, or other components the client computing device 110 can provide the audio input signal to the data processing system 108 (e.g., via the network 106) where it can be received (e.g., by the interface 115) and provided to the NLP component 160 or stored in the data repository 145 as content data 148.

The NLP component 160 can receive or otherwise obtain the input audio signal. From the input audio signal, the NLP component 160 can identify at least one request or at least one trigger keyword corresponding to the request. The request can indicate intent or subject matter of the input audio signal. The trigger keyword can indicate a type of action likely to be taken. For example, the NLP component 160 can parse the input audio signal to identify at least one request to go to the beach for the weekend. The trigger keyword can include at least one word, phrase, root or partial word, or derivative indicating an action to be taken. For example, the trigger keyword “go” or “to go to” from the input audio signal can indicate a need for transport or a trip away from home. In this example, the input audio signal (or the identified request) does not directly express an intent for transport, however the trigger keyword indicates that transport is an ancillary action to at least one other action that is indicated by the request.

The prediction component 120 (or other mechanism of the data processing system 108) can generate, based on the request or the trigger keyword, at least one action data structure associated with the input audio signal. The action data structure can indicate information related to subject matter of the input audio signal. The action data structure can include one or more than one action, such as organic responses to the input audio signal. For example, the input audio signal “OK, I would like to go to the beach this weekend” can include at least one request indicating an interest for a beach weather forecast, surf report, or water temperature information, and at least one trigger keyword, e.g., “go” indicating travel to the beach, such as a need for items one may want to bring to the beach, or a need for transportation to the beach. The prediction component 120 can generate or identify subject matter for at least one action data structure, an indication of a request for a beach weather forecast, as well as subject matter for a content item, such as an indication of a query for sponsored content related to spending a day at a beach. From the request or the trigger keyword the prediction component 120 (or other system 100 component such as the NLP component 160 or the direct action API 135) predicts, estimates, or otherwise determines subject matter for action data structures or for content items. From this subject matter, the direct action API 135 can generate at least one action data structure and can communicate with at least one content provider computing device 104 to obtain at least one content item 155. The prediction component 120 can access the parameters 146 or policies 147 in the data repository 145 to determine or otherwise estimate requests for action data structures or content items. For example, the parameters 146 or policies 147 could indicate requests for a beach weekend weather forecast action or for content items related to beach visits, such as a content item for sunscreen.

The content selector component 125 can obtain indications of any of the interest in or request for the action data structure or for the content item. For example, the prediction component 120 can directly or indirectly (e.g., via the data repository 145) provide an indication of the action data structure or content item to the content selector component 125. The content selector component 125 can obtain this information from the data repository 145, where it can be stored as part of the content data 148. The indication of the action data structure can inform the content selector component 125 of a need for area beach information, such as a weather forecast or products or services the end user may need for a trip to the beach.

From the information received by the content selector component 125, e.g., an indication of a forthcoming trip to the beach, the content selector component 125 can identify at least one content item. The content item can be responsive or related to the subject matter of the input audio query. For example, the content item can include data message identifying as tore near the beach that has sunscreen, or offering a taxi ride to the beach. The content selector component 125 can query the data repository 145 to select or otherwise identify the content item, e.g., from the content data 148. The content selector component 125 can also select the content item from the content provider computing device 104. For example responsive to a query received from the data processing system 108, the content provider computing device 104 can provide a content item to the data processing system 108 (or component thereof) for eventual output by the client computing device 110 that originated the input audio signal, or for output to the same end user by a different client computing device 110.

The audio signal generator component 130 can generate or otherwise obtain an output signal that includes the content item (as well as the action data structure) responsive to the input audio signal. For example, the data processing system 108 can execute the audio signal generator component 130 to generate or create an output signal corresponding to the action data structure or to the content item. The interface component 115 of the data processing system 108 can provide or transmit one or more data packets that include the output signal via the computer network 106 to any client computing device 110. The interface 115 can be designed, configured, constructed, or operational to receive and transmit information using, for example, data packets. The interface 115 can receive and transmit information using one or more protocols, such as a network protocol. The interface 115 can include a hardware interface, software interface, wired interface, or wireless interface. The interface 115 can facilitate translating or formatting data from one format to another format. For example, the interface 115 can include an application programming interface that includes definitions for communicating between various components, such as software components of the system 100.

The data processing system 108 can provide the output signal including the action data structure from the data repository 145 or from the audio signal generator component 130 to the client computing device 110. The data processing system 108 can provide the output signal including the content item from the data repository 145 or from the audio signal generator component 130 to the same or to a different client computing device 110.

The data processing system 108 can also instruct, via data packet transmissions, the content provider computing device 104 or the service provider computing device 102 to provide the output signal (e.g., corresponding to the action data structure or to the content item) to the client computing device 110. The output signal can be obtained, generated, transformed to or transmitted as one or more data packets (or other communications protocol) from the data processing system 108 (or other computing device) to the client computing device 110.

The content selector component 125 can select the content item or the action data structure for the as part of a real-time content selection process. For example, the action data structure can be provided to the client computing device 110 for transmission as audio output by an interface of the client computing device 110 in a conversational manner in direct response to the input audio signal. The real-time content selection process to identify the action data structure and provide the content item to the client computing device 110 can occur within one minute or less from the time of the input audio signal and be considered real-time. The data processing system 108 can also identify and provide the content item to at least one interface of the client computing device 110 that originated the input audio signal, or to a different client computing device 110.

The action data structure (or the content item), for example obtained or generated by the audio signal generator component 130 transmitted via the interface 115 and the computer network 106 to the client computing device 110, can cause the client computing device 110 to execute the audio driver 153 to drive the speaker 154 to generate an acoustic wave corresponding to the action data structure or to the content item. The acoustic wave can include words of or corresponding to the action data structure or content item.

The acoustic wave representing the action data structure can be output from the client computing device 110 separately from the content item. For example, the acoustic wave can include the audio output of “Today it will be sunny and 80 degrees at the beach.” In this example, the data processing system 108 obtains the input audio signal of, for example, “OK, I would like to go to the beach this weekend.” From this information the NLP component 160 identifies at least one request or at least one trigger keyword, and the prediction component 120 uses the request(s) or trigger keyword(s) to identify a request for an action data structure or for a content item. The content selector component 125 (or other component) can identify, select, or generate a content item for, e.g., sunscreen available near the beach. The direct action API 135 (or other component) can identify, select, or generate an action data structure for, e.g., the weekend beach forecast. The data processing system 108 or component thereof such as the audio signal generator component 130 can provide the action data structure for output by an interface of the client computing device 110. For example, the acoustic wave corresponding to the action data structure can be output from the client computing device 110. The data processing system 108 can provide the content item for output by a different interface of the same client computing device 110 or by an interface of a different client computing device 110.

The packet based data transmission of the action data structure by data processing system 108 to the client computing device 110 can include a direct or real-time response to the input audio signal of “OK, I would like to go to the beach this weekend” so that the packet based data transmissions via the computer network 106 that are part of a communication session between the data processing system 108 and the client computing device 110 with the flow and feel of a real-time person to person conversation. This packet based data transmission communication session can also include the content provider computing device 104 or the service provider computing device 102.

The content selector component 125 can select the content item or action data structure based on at least one request or at least one trigger keyword of the input audio signal. For example, the requests of the input audio signal “OK, I would like to go to the beach this weekend” can indicate subject matter of the beach, travel to the beach, or items to facilitate a trip to the beach. The NLP component 160 or the prediction component 120 (or other data processing system 108 components executing as part of the direct action API 135) can identify the trigger keyword “go” “go to” or “to go to” and can determine a transportation request to the beach based at least in part on the trigger keyword. The NLP component 160 (or other system 100 component) can also determine a solicitation for content items related to beach activity, such as for sunscreen or beach umbrellas. Thus, the data processing system 108 can infer actions from the input audio signal that are secondary requests (e.g., a request for sunscreen) that are not the primary request or subject of the input audio signal (information about the beach this weekend).

The action data structures and content items can correspond to subject matter of the input audio signal. The direct action API 135 can execute programs or scripts, for example from the NLP component 160, the prediction component 120, or the content selector component 125 to identify action data structures or content items for one or more of these actions. The direct action API 135 can execute a specified action to satisfy the end user's intention, as determined by the data processing system 108. Depending on the action specified in its inputs, the direct action API 135 can execute code or a dialog script that identifies the parameters required to fulfill a user request. Such code can lookup additional information, e.g., in the data repository 145, such as the name of a home automation service, or it can provide audio output for rendering at the client computing device 110 to ask the end user questions such as the intended destination of a requested taxi. The direct action API 135 can determine necessary parameters and can package the information into an action data structure, which can then be sent to another component such as the content selector component 125 or to the service provider computing device 102 to be fulfilled.

The direct action API 135 of the data processing system 108 can generate, based on the request or the trigger keyword, the action data structures. The action data structures can be generated responsive to the subject matter of the input audio signal. The action data structures can be included in the messages that are transmitted to or received by the service provider computing device 102. Based on the audio input signal parsed by the NLP component 160, the direct action API 135 can determine to which, if any, of a plurality of service provider computing devices 102 the message should be sent. For example, if an input audio signal includes “OK, I would like to go to the beach this weekend,” the NLP component 160 can parse the input audio signal to identify requests or trigger keywords such as the trigger keyword word “to go to” as an indication of a need for a taxi. The direct action API 135 can package the request into an action data structure for transmission as a message to a service provider computing device 102 of a taxi service. The message can also be passed to the content selector component 125. The action data structure can include information for completing the request. In this example, the information can include a pick up location (e.g., home) and a destination location (e.g., a beach). The direct action API 135 can retrieve a template 149 from the data repository 145 to determine which fields to include in the action data structure. The direct action API 135 can retrieve content from the data repository 145 to obtain information for the fields of the data structure. The direct action API 135 can populate the fields from the template with that information to generate the data structure. The direct action API 135 can also populate the fields with data from the input audio signal. The templates 149 can be standardized for categories of service providers or can be standardized for specific service providers. For example, ride sharing service providers can use the following standardized template 149 to create the data structure: {client_{deviceidentifier}; authentication_{credentials}; pick_{uplocation}; destination_{location}; no_{passengers}; serviceₗₑᵥₑₗ}.

The content selector component 125 can identify, select, or obtain multiple content items resulting from a multiple content selection processes. The content selection processes can be real-time, e.g., part of the same conversation, communication session, or series of communications sessions between the data processing system 108 and the client computing device 110 that involve common subject matter. The conversation can include asynchronous communications separated from one another by a period of hours or days, for example. The conversation or communication session can last for a time period from receipt of the first input audio signal until an estimated or known conclusion of a final action related to the first input audio signal, or receipt by the data processing system 108 of an indication of a termination or expiration of the conversation. For example, the data processing system 108 can determine that a conversation related to a weekend beach trip begins at the time or receipt of the input audio signal and expires or terminates at the end of the weekend, e.g., Sunday night or Monday morning. The data processing system 108 that provides action data structures or content items for rendering by one or more interfaces of the client computing device 110 or of another client computing device 110 during the active time period of the conversation (e.g., from receipt of the input audio signal until a determined expiration time) can be considered to be operating in real-time. In this example the content selection processes and rendering of the content items and action data structures occurs in real time.

The interface management component 140 can poll, determine, identify, or select interfaces for rendering of the action data structures and of the content items related to the input audio signal. For example, the interface management component 140 can identify one or more candidate interfaces of client computing devices 110 associated with an end user that entered the input audio signal (e.g., “What is the weather at the beach today?”) into one of the client computing devices 110 via an audio interface. The interfaces can include hardware such as sensor 151 (e.g., a microphone), speaker 154, or a screen size of a computing device, alone or combined with scripts or programs (e.g., the audio driver 153) as well as apps, computer programs, online documents (e.g., webpage) interfaces and combinations thereof.

The interfaces can include social media accounts, text message applications, or email accounts associated with an end user of the client computing device 110 that originated the input audio signal. Interfaces can include the audio output of a smartphone, or an app based messaging device installed on the smartphone, or on a wearable computing device, among other client computing devices 110. The interfaces can also include display screen parameters (e.g., size, resolution), audio parameters, mobile device parameters, (e.g., processing power, battery life, existence of installed apps or programs, or sensor 151 or speaker 154 capabilities), content slots on online documents for text, image, or video renderings of content items, chat applications, laptops parameters, smartwatch or other wearable device parameters (e.g., indications of their display or processing capabilities), or virtual reality headset parameters.

The interface management component 140 can poll a plurality of interfaces to identify candidate interfaces. Candidate interfaces include interfaces having the capability to render a response to the input audio signal, (e.g., the action data structure as an audio output, or the content item that can be output in various formats including non-audio formats). The interface management component 140 can determine parameters or other capabilities of interfaces to determine that they are (or are not) candidate interfaces. For example, the interface management component 140 can determine, based on parameters 146 of the content item or of a first client computing device 110 (e.g., a smartwatch wearable device), that the smartwatch includes an available visual interface of sufficient size or resolution to render the content item. The interface management component 140 can also determine that the client computing device 110 that originated the input audio signal has a speaker 154 hardware and installed program e.g., an audio driver or other script to render the action data structure.

The interface management component 140 can determine utilization values for candidate interfaces. The utilization values can indicate that a candidate interface can (or cannot) render the action data structures or the content items provided in response to input audio signals. The utilization values can include parameters 146 obtained from the data repository 145 or other parameters obtained from the client computing device 110, such as bandwidth or processing utilizations or requirements, processing power, power requirements, battery status, memory utilization or capabilities, or other interface parameters that indicate the available of an interface to render action data structures or content items. The battery status can indicate a type of power source (e.g., internal battery or external power source such as via an output), a charging status (e.g., currently charging or not), or an amount of remaining battery power. The interface management component 140 can select interfaces based on the battery status or charging status.

The interface management component 140 can order the candidate interfaces in a hierarchy or ranking based on the utilization values. For example different utilization values (e.g., processing requirements, display screen size, accessibility to the end user) can be given different weights. The interface management component 140 can rank one or more of the utilization values of the candidate interfaces based on their weights to determine an optimal corresponding candidate interface for rendering of the content item (or action data structure). Based on this hierarchy, the interface management component 140 can select the highest ranked interface for rendering of the content item.

Based on utilization values for candidate interfaces, the interface management component 140 can select at least one candidate interface as a selected interface for the content item. The selected interface for the content item can be the same interface from which the input audio signal was received (e.g., an audio interface of the client computing device 110) or a different interface (e.g., a text message based app of the same client computing device 110, or an email account accessible from the same client computing device 110.

The interface management component 140 can select an interface for the content item that is an interface of a different client computing device 110 than the device that originated the input audio signal. For example, the data processing system 108 can receive the input audio signal from a first client computing device 110 (e.g., a smartphone), and can select an interface such as a display of a smartwatch (or any other client computing device for rendering of the content item. The multiple client computing devices 110 can all be associated with the same end user. The data processing system 108 can determine that multiple client computing devices 110 are associated with the same end user based on information received with consent from the end user such as user access to a common social media or email account across multiple client computing devices 110.

The interface management component 140 can also determine that an interface is unavailable. For example the interface management component 140 can poll interfaces and determine that a battery status of a client computing device 110 associated with the interface is low, or below a threshold level such as 10%. Or the interface management component 140 can determine that the client computing device 110 associated with the interface lacks sufficient display screen size or processing power to render the content item, or that the processor utilization rate is too high, as the client computing device is currently executing another application, for example to stream content via the network 106. In these and other examples the interface management component 140 can determine that the interface is unavailable and can eliminate the interface as a candidate for rendering the content item or the action data structure.

Thus, the interface management component 140 can determine that a candidate interface accessible by the first client computing device 110 is linked to an account of an end user, and that a second candidate interface accessible by a second client computing device 110 is also linked to the same account. For example, both client computing devices 110 may have access to the same social media account, e.g., via installation of an app or script at each client computing device 110. The interface management component 140 can also determine that multiple interfaces correspond to the same account, and can provide multiple, different content items to the multiple interfaces corresponding to the common account. For example, the data processing system 108 can determine, with end user consent, that an end user has accessed an account from different client computing devices 110. These multiple interfaces can be separate instances of the same interface (e.g., the same app installed on different client computing devices 110) or different interfaces such as different apps for different social media accounts that are both linked to a common email address account, accessible from multiple client computing devices 110.

The interface management component 140 can also determine or estimate distances between client computing devices 110 associated with candidate interfaces. For example, the data processing system 108 can obtain, with user consent, an indication that the input audio signal originated from a smartphone or virtual reality headset computing device, and that the end user is associated with an active smartwatch client computing device 110. From this information the interface management component can determine that the smartwatch is active, e.g., being worn by the end user when the end user enters the input audio signal into the smartphone, so that the two client computing devices 110 are within a threshold distance of one another. In another example, the data processing system 108 can determine, with end user consent, the location of a smartphone that is the source of an input audio signal, and can also determine that a laptop account associated with the end user is currently active. For example, the laptop can be signed into a social media account indicating that the user is currently active on the laptop. In this example the data processing system 108 can determine that the end user is within a threshold distance of the smartphone and of the laptop, so that the laptop can be an appropriate choice for rendering of the content item via a candidate interface.

The interface management component 140 can select the interface for the content item based on at least one utilization value indicating that the selected interface is the most efficient for the content item. For example, from among candidate interfaces, the interface to render the content item at the smartwatch uses the least bandwidth due as the content item is smaller and can be transmitted with fewer resources. Or the interface management component 140 can determine that the candidate interface selected for rendering of the content item is currently charging (e.g., plugged in) so that rendering of the content item by the interface will not drain battery power of the corresponding client computing device 110. In another example, the interface management component 140 can select a candidate interface that is currently performing fewer processing operations than another, unselected interface of for example a different client computing device 110 that is currently streaming video content from the network 106 and therefore less available to render the content item without delay.

The interface management component 140 (or other data processing system 108 component) can convert the content item for delivery in a modality compatible with the candidate interface. For example, if the candidate interface is a display of a smartwatch, smartphone, or tablet computing device, the interface management component 140 can size the content item for appropriate visual display given the dimensions of the display screen associated with the interface. The interface management component 140 can also convert the content item to a packet or other protocol based format, including proprietary or industry standard format for transmission to the client computing device 110 associated with the selected interface. The interface selected by the interface management component 140 for the content item can include an interface accessible from multiple client computing devices 110 by the end user. For example, the interface can be or include a social media account that the end user can access via the client computing device 110 that originated the input audio signal (e.g., a smartphone) as well as other client computing devices such as tabled or desktop computers or other mobile computing devices.

The interface management component 140 can also select at least one candidate interface for the action data structure. This interface can be the same interface from which the input audio signal was obtained, e.g., a voice activated assistant service executed at a client computing device 110. This can be the same interface or a different interface than the interface management component 140 selects for the content item. The interface management component 140 (or other data processing system 108 components) can provide the action data structure to the same client computing device 110 that originated the input audio signal for rendering as audio output as part of the assistant service. The interface management component 140 can also transmit or otherwise provide the content item to the selected interface for the content item, in any converted modality appropriate for rendering by the selected interface.

Thus, the interface management component 140 can provide the action data structure as audio output for rendering by an interface of the client computing device 110 responsive to the input audio signal received by the same client computing device 110. The interface management component 140 can also provide the content item for rendering by a different interface of the same client computing device 110 or of a different client computing device 110 associated with the same end user. For example, the action data structure, e.g., “it will be sunny and 80 degrees at the beach on Saturday” can be provided for audio rendering by the client computing device as part of an assistant program interface executing in part at the client computing device 110, and the content item e.g., a text, audio, or combination content item indicating that “sunscreen is available from the convenience store near the beach” can be provided for rendering by an interface of the same or a different computing device 110, such as an email or text message accessible by the same or a different client computing device 110 associated with the end user. Separating the content item from the action data structure and sending the content item as, for example, a text message rather than an audio message can result in reduced processing power for the client computing device 110 that accesses the content item since, for example, text message data transmissions are less computationally intensive than audio message data transmissions. This separation can also reduce power usage, memory storage, or transmission bandwidth used to render the content item. This results in increased processing, power, and bandwidth efficiencies of the system 100 and devices such as the client computing devices 110 and the data processing system 108. This increases the efficiency of the computing devices that process these transactions, and increases the speed with which the content items can be rendered. The data processing system 108 can process thousands, tens of thousands or more input audio signals simultaneously so the bandwidth, power, and processing savings can be significant and not merely incremental or incidental.

The interface management component 140 can provide or deliver the content item to the same client computing device 110 (or a different device) as the action data structure subsequent to delivery of the action data structure to the client computing device 110. For example, the content item can be provided for rendering via the selected interface upon conclusion of audio output rendering of the action data structure. The interface management component 140 can also provide the content item to the selected interface concurrent with the provision of the action data structure to the client computing device 110. The interface management component 140 can provide the content item for delivery via the selected interface within a pre-determined time period from receipt of the input audio signal by the NLP component 160. The time period, for example, can be any time during an active length of the conversation of session. For example, if the input audio signal is “I would like to go to the beach this weekend” the pre-determined time period can be any time from receipt of the input audio signal through the end of the weekend, e.g., the active period of the conversation. The pre-determined time period can also be a time triggered from rendering of the action data structure as audio output by the client computing device 110, such as within 5 minutes, one hour or one day of this rendering.

The interface management component 140 can provide the action data structure to the client computing device 110 with an indication of the existence of the content item. For example, the data processing system 108 can provide the action data structure that renders at the client computing device 110 to provide the audio output “it will be sunny and 80 degrees at the beach on Saturday, check your email for more information.” The phrase “check your email for more information” can indicate the existence of a content item, e.g., for sunscreen, provided by the data processing system 108 to an interface (e.g., email). In this example, sponsored content can be provided as content items to the email (or other) interface and organic content such as the weather can be provided as the action data structure for audio output.

The data processing system 108 can also provide the action data structure with a prompt that queries the user to determine user interest in obtaining the content item. For example, the action data structure can indicate “it will be sunny and 80 degrees at the beach on Saturday, would you like to hear about some services to assist with your trip?” The data processing system 108 can receive another audio input signal from the client computing device 110 in response to the prompt “would you like to hear about some services to assist with your trip?” such as “sure”. The NLP component 160 can parse this response, e.g., “sure” and interpret it as authorization for audio rendering of the content item by the client computing device 110. In response, the data processing system 108 can provide the content item for audio rendering by the same client computing device 110 from which the response “sure” originated.

The data processing system 108 can delay transmission of the content item associated with the action data structure to optimize processing utilization. For example, the data processing system 108 provide the action data structure for rendering as audio output by the client computing device in real-time responsive to receipt of the input audio signal, e.g., in a conversational manner, and can delay content item transmission until an off-peak or non-peak period of data center usage, which results in more efficient utilization of the data center by reducing peak bandwidth usage, heat output or cooling requirements. The data processing system 108 can also initiate a conversion or other activity associated with the content item, such as ordering a car service responsive to a response to the action data structure or to the content item, based on data center utilization rates or bandwidth metrics or requirements of the network 106 or of a data center that includes the data processing system 108.

Based on a response to a content item or to the action data structure for a subsequent action, such as a click on the content item rendered via the selected interface, the data processing system 108 can identify a conversion, or initiate a conversion or action. Processors of the data processing system 108 can invoke the direct action API 135 to execute scripts that facilitate the conversion action, such as to order a car from a car share service to take the end user to or from the beach. The direct action API 135 can obtain content data 148 (or parameters 146 or policies 147) from the data repository 145, as well as data received with end user consent from the client computing device 110 to determine location, time, user accounts, logistical or other information in order to reserve a car from the car share service. Using the direct action API 135, the data processing system 108 can also communicate with the service provider computing device 102 to complete the conversion by in this example making the car share pick up reservation.

FIG. 1C depicts a flow diagram 230 for multi-modal transmission of packetized data in a voice activated computer network environment. The data processing system 108 can receive the input audio signal 235, e.g., “OK, I would like to go to the beach this weekend.” In response, the data processing system generates at least one action data structure 240 and at least one content item 255. The action data structure 240 can include organic or non-sponsored content, such as a response for audio rendering stating “It will be sunny and 80 degrees at the beach this weekend” or “high tide is at 3 pm.” The data processing system 108 can provide the action data structure 240 to the same client computing device 110 that originated the input audio signal 235, for rendering by a candidate interface of the client computing device 110, e.g., as output in a real time or conversational manner as part of a digital or conversational assistant platform.

The data processing system 108 can select the candidate interface 250 as a selected interface for the content item 255, and can provide the content item 255 to the selected interface 250. The content item 255 can also include a data structure, converted to the appropriate modality by the data processing system 108 for rendering by the selected interface 250. The content item 255 can include sponsored content, such as an offer to rent a beach chair for the day, or for sunscreen. The selected interface 250 can be part of or executed by the same client computing device 110 or by a different device accessible by the end user of the client computing device 110. Transmission of the action data structure 240 and the content item 255 can occur at the same time or subsequent to one another. The action data structure 240 can include an indicator that the content item 255 is being or will be transmitted separately via a different modality or format to the selected interface 250, alerting the end user to the existence of the content item 255.

The action data structure 240 and the content item 255 can be provided separately for rendering to the end user. By separating the sponsored content (content item 255) from the organic response (action data structure 240) audio or other alerts indicating that the content item 255 is sponsored do not need to be provided with the action data structure 240. This can reduce bandwidth requirements associated with transmission of the action data structure 240 via the network 106 and can simplify rendering of the action data structure 240, for example without audio disclaimer or warning messages.

The data processing system 108 can receive a response audio signal 245. The response audio signal 245 can include an audio signal such as, “great, please book me a hotel on the beach this weekend.” Receipt by the data processing system 108 of the response audio signal 245 can cause the data processing system to invoke the direct action API 135 to execute a conversion to, for example, book a hotel room on the beach. The direct action API 135 can also communicate with at least one service provider computing device 102 to provide information to the service provider computing device 102 so that the service provider computing device 102 can complete or confirm the booking process.

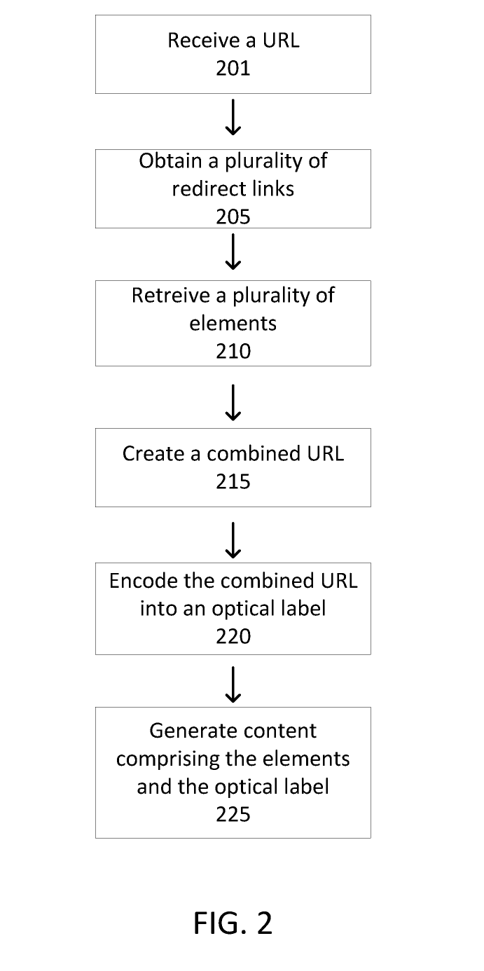

FIG. 2 is a flowchart depicting one embodiment of a method for automatic content generation. The method generally includes receiving a URL (ACT 201), obtaining a plurality of redirect links (ACT 205), retrieving a plurality of elements from a webpage referenced by the URL, and creating a combined URL (ACT 215). The method further includes encoding the combined URL into a label (ACT 220) and generating content comprising the elements and the label (ACT 225).

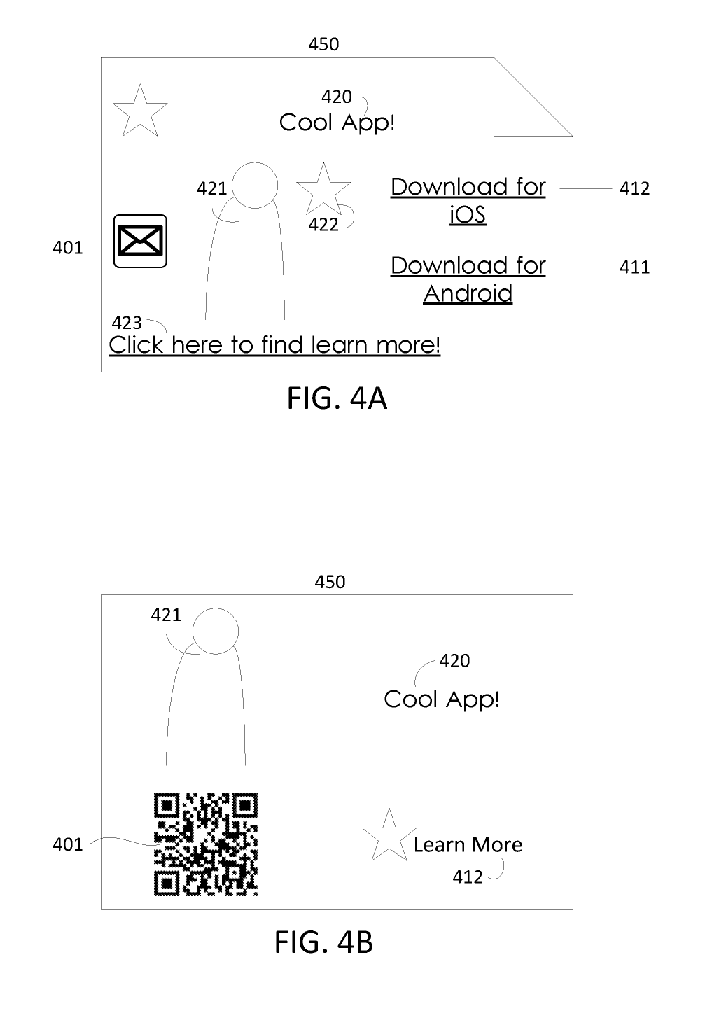

Specifically, the method includes receiving a URL (ACT 201). The URL may be sent from a third-party content provider. The URL references a webpage. The webpage may contain digital components related to a product, contain offers, coupons, promotions, links to a mobile application, or any other content. The webpage is described in further detail in FIG. 4 below.

As shown in FIG. 2, the method further includes obtaining a plurality of redirect links (ACT 205). In some implementations, one or more redirect links may be received along with the URL. The redirect links may reference redirect pages that contain, for example, coupons or promotions. The redirect pages may also contain download links to platform-specific mobile applications, browser-specific plug-ins, or any other software. The redirect pages may also be webpages that correspond to some information specified in user settings, history, or cookies. In some implementations, when redirect links are linked from the webpage referenced by the received URL, the redirect links may be obtained from the webpage.

The method further includes retrieving a plurality of elements (ACT 210) from the webpage referenced by the URL. The elements include, for example, images, styles, headlines, links, and texts. The webpage and elements are described in further detail in FIGS. 4A and 4B below. In some implementations, retrieving the element may be done by a web crawler. In some implementations, the webpage is accessed then parsed for elements. For example, document object model nodes may be parsed to retrieve the relevant elements. An ad suggestion tool may retrieve the most relevant elements of the webpage. Elements include, for example, images, styles, headlines, links, and texts. A ranking algorithm may determine which image on the webpage is a product image or a logo image. The ranking algorithm may also be used to determine which headline or text on the webpage is a product name or a description of the product. The ranking algorithm may also consider the position or size of an element. For example, the ranking algorithm may rank the largest image on the webpage to be important. The ranking algorithm may also examine the metadata of the elements. For example, the ranking algorithm may suggest that an image with a metadata labelling it a screenshot be used as the background of the generated ad. The ranking algorithm may retrieve redirect links by examining metadata associated with links on the webpage. The ranking algorithm may also examine the URL of the links. For example, the ranking algorithm may examine a link and determine that it references a mobile application download page. For another example, the ranking algorithm may retrieve a link to another webpage in the same website that contains additional product information. Generally, the ranking algorithm may examine any part of the webpage, the document object model nodes, or resources referenced by the webpage to rank and retrieve relevant elements and links.

The method further includes creating a combined URL (ACT 215). The combined URL comprises the redirect links and a click server URL. A click server may be part of the content item management service. In some implementations, the content item management service manages a plurality of click servers. The click server URL references the click server such that a computing device connected to the Internet or to a same network can send a request to the click server using the click server URL. The click server URL may be retrieved from the click server or from the content item management service. The redirect links are obtained from the webpage or specified by the third-party content provider. Each redirect page may correspond to a platform-specific app, a browser-specific plugin, or any software that may be specified by a user settings, history, or cookies. The redirect links are combined with the click server URL to form a combined URL. In some implementations, the combined URL is created by concatenating the click server URL with the redirect links. The combined URL may contain the click server URL, some delimiting characters, and at least one of the redirect links. In some implementations, additional information may be added to the combined URL. For example, the combined URL may also comprise platform information of each redirect link that corresponds to platform-specific mobile application download page. In some implementations, the combined URL may contain a content item management account information or content item identifier. The click server URL may be at the beginning of the combined URL, and the redirect URLs and information are concatenated as query strings. In some implementations, the combined URL may be shortened. The combined URL or the shortened URL still allows a client device connected to the Internet or to a same network to send a request to the click server.

The method further includes encoding the combined URL in a label (ACT 220). In one example the label is an optical label. The optical label may be a QR code, a bar code, or a matrix barcode. Some labels may have specific requirements, such as contrast between colors used in the label. Label encoding can be performed by software or a hardware module. Some labels may contain error correction. For example, QR codes may be processed using Reed-Solomon error correction. Some labels may contain intentional errors that make labels more readable or attractive to the human eye while still allowing the label to be scanned correctly. Intentional errors may include colors, logos, and other embellishments. An implementation of a label is shown as part of FIG. 4B below.

The label can also be a voiceprint label or a videoprint label. The videoprint label can be similar to a moving barcode. For example, each frame of the video is a different bar code or the videoprint label can include intermittent flashes. A computing device can use its camera to scan the videoprint label and decode the data contained in the videoprint label. A voiceprint label can also be referred to as an audioprint label. The voiceprint label can include sub-audible tones that can be detected by the transducer of the computing device. The sub-audible tones can enable two computing devices to transfer information when within a range of one another that the sub-audible tones can travel. In some implementations, the voiceprint can include audible tones. The voiceprint can also include human understandable tones, such as a computer-generated voice.

The method further includes generating content comprising the elements and the label (ACT 225). A layout algorithm may be used to generate the content. The layout algorithm may arrange the elements based on the relative importance, size, or shape of each element. As an example, the layout algorithm may use an image element from the website labeled as a screenshot as a background of the content. In some implementations, the layout algorithm may fulfill specific requirements of the label. The layout algorithm may arrange the elements so as to not obstruct any part of the label. In some implementations, the layout algorithm may allow some part of the label to be obstructed while still allowing the label to be scanned correctly. The layout algorithm may specify the label to be in a specific spot, such as, for example, the lower right corner of the ad. For example, QR codes require high contrast between the two colors used in the code, and so the layout algorithm may use a white background for the area around the QR code. The layout algorithm may also specify that the label be of a certain size. The method may also include adding a link to the webpage, the redirect pages, or other webpages. The generated content can be or include a digital component, an implementation of which is described in FIG. 4B below.

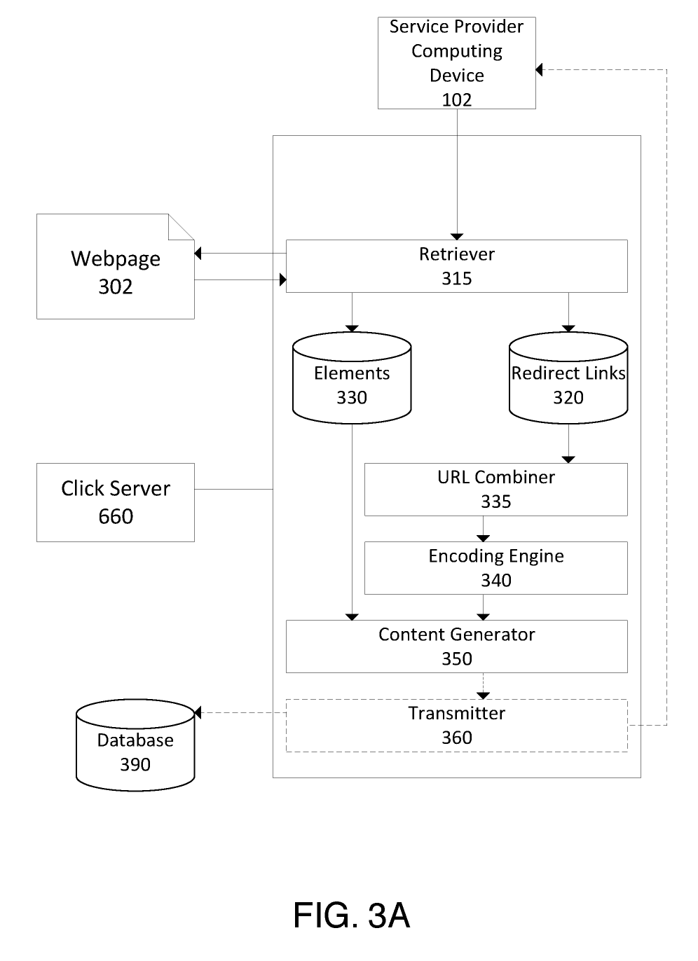

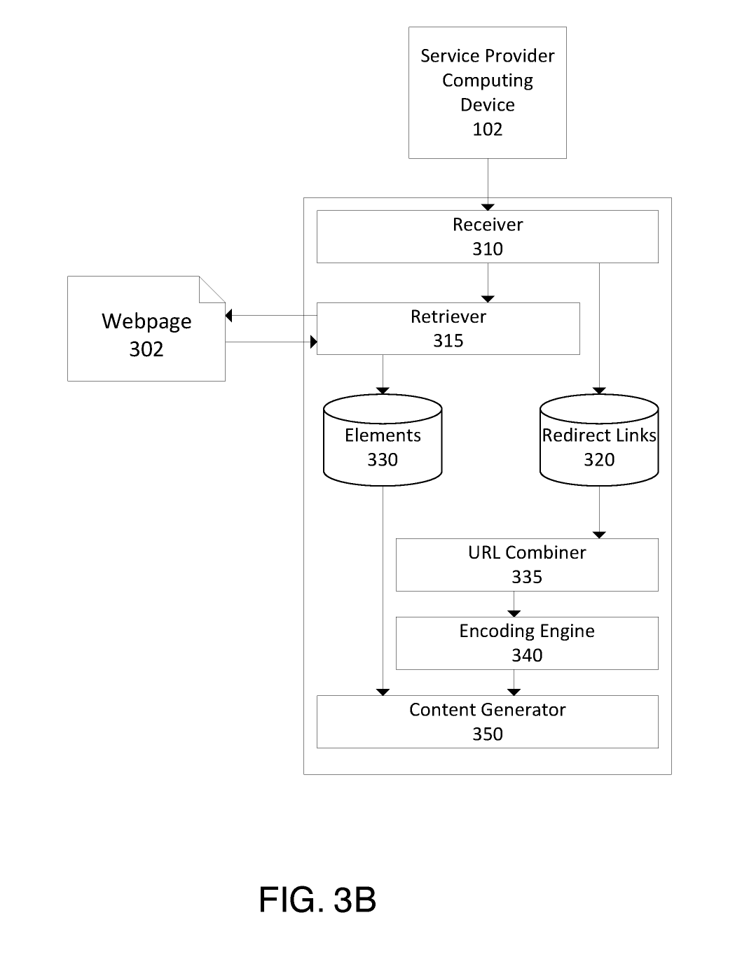

FIG. 3A is a schematic diagram of a content generation system. The content generation system can be a component of the data processing system 108. The content generation system can include a retriever 315, memory storing webpage elements 330, memory storing redirect links 320, URL combiner 335, encoding engine 340, and content generator 350. Some implementations also include a transmitter 360. In general, the elements of the system may be implemented as software, hardware, or as some combination of both.

The retriever 315 may receive a URL from a service provider computing device 102. The retriever 315 then accesses a webpage 302 referenced by the URL. The retriever 315 may then use a ranking algorithm to retrieve webpage elements and redirect links in the webpage 302. The retrieved elements and redirect links are stored in memory 330 and 320.

The memory storing webpage elements 330 and redirect links 320 may be volatile memory, non-volatile memory, or part of a database. Each webpage element may store corresponding relative rank as determined by the ranking algorithm. In addition, each webpage element may also store metadata or description of the respective element. The memory storing redirect links 320 may also store a corresponding metadata or description of each respective redirect link. For example, a metadata may specify a mobile platform that corresponds to the respective redirect link.

The URL combiner 335 combines a click server URL with the redirect links stored in memory 320. The content generation system may be connected with a click server 660 or a plurality of click servers. The content generation system and the click server 660 may be part of a content item management service. The URL combiner 335 may receive a click server URL from the content item management service. The URL combiner 335 may combine the clicker server URL with the redirect links. The URL combiner 335 may insert some delimiting characters. Additional information may be part of the combined URL as well, such as metadata stored with respective redirect links. The combined URL may allow a client device to send a request to the click server through a network. In some implementations, the URL combiner 335 shortens the combined URL before sending it to the encoding engine 340.

The encoding engine 340 may encode the combined URL into a label. The label may be a QR code, a bar code, or a matrix barcode. An implementation of a label is shown as part of FIG. 4B below. The encoding engine 340 may encode the combined URL according to specific requirements of the label, such as level of error correction, contrast between the colors used, and size. The encoding engine 340 may provide the created label and label requirements to the content generator 350.

The content generator 350 reads the memory storing the webpage elements 330 and receives from the encoding engine 340 a label. The content generator 350 may also receive additional parameters or limitations such as label requirements from the encoding engine 340. The content generator 350 may also receive, for example, the relative ranks or metadata of each webpage elements. The content generator 350 may include a layout algorithm. The layout algorithm may examine the relative ranks and metadata of each webpage elements to generate the content. For example, a webpage element may contain metadata specifying the webpage as a screenshot. The layout algorithm may analyze the webpage element and use it as a background of the content. The label may have additional limitations, such as placement within the content and how much it can be obscured by other elements. The layout algorithm takes into account all the received parameters and limitations and generates content.

Some implementations have a transmitter 360. The transmitter receives the generated content and transmits it to the service provider computing device 102 and the database 390. In some implementations, the transmitter 360 presents the generated content to the service provider computing device 102. The transmitter 360 may allow the service provider computing device 102 to approve of or modify the generated content. The service provider computing device 102 may modify the content by changing the location, size, color, or style of individual elements, as well as providing different elements for the content. After the service provider computing device 102 modifies or approves the content, the transmitter 360 receives the modified or approved content. The transmitter 360 then transmits the content to a database 390. The database 390 may be a database of the data processing system 108. The database 390 may also store content item management account information or content item identifier corresponding to the ad.

FIG. 3B is a schematic diagram of one implementation of a content generation system that includes a receiver. The receiver 310 receives a URL of a webpage from the third-party provider. The receiver 310 may also receive one or more redirect links from the third-party provider. The receiver stores the received redirect links in memory 320, and sends the webpage URL to the retriever 315. The retriever 315 then retrieves webpage elements from the webpage. In some implementations, the retriever 315 also retrieves additional redirect links from the webpage and stores them in memory 320.

FIG. 4A depicts an implementation of a webpage specified by a service provider computing device 102. The webpage 450, which can be a digital component or include multiple digital components, may be constructed in a markup language, such as hypertext markup language (HTML). The webpage 450 may contain information about a product, an app, a promotion, a coupon, a service, or any other content. The webpage 450 may further contain images, styles, headlines, links, texts, icons, colors, shapes, sizes, positions, backgrounds, animations, videos, etc. that the retriever 315 may retrieve to generate the content.

The webpage 450 may also contain element metadata. The ranking algorithm may use metadata to determine which elements to retrieve, and the layout algorithm may use metadata and relative ranks of each element to arrange the elements. For example, the ranking algorithm may analyze each element to rank its importance; it may retrieve a link, and analyze it to determine that it identifies a mobile application download page which may have a high relative rank. As another example, the ranking algorithm may retrieve a link that points to additional product information page. The ranking algorithm may retrieve that link and the layout algorithm may include the link in the generated content. As a further example, the ranking algorithm may examine the metadata or the filename of an image and infer that it is a screenshot of a game. The layout algorithm may use the screenshot as a background of the ad.

As shown in FIG. 4A, a webpage 450, also referred to as a digital component, may contain an image 421, redirect link to additional product information 423, text 420, icons 422, and platform-specific mobile application links. The ranking algorithm may rank some of these items as more important than others, and it may retrieve the items that have relatively higher rank than other elements. In some implementations, the ranking element may retrieve all elements and store the relative rank of each element in memory.

FIG. 4B depicts an implementation of generated content corresponding to the webpage depicted in FIG. 4A. Digital component 450 contains various elements from the webpage described in relation to FIG. 4B. The content may contain texts 411, images 410, icons, and links 412. The content also contains a label 401. Selecting the label 401 can cause a voiceprint or videoprint to be rendered by the device displaying the content 450. The images, styles, headlines, links, texts, icons, colors, shapes, sizes, positions, backgrounds, animations, videos, etc. may all be elements that are retrieved by the retriever 315 from the webpage using a ranking algorithm. A layout algorithm may arrange these elements along with the label 401. Some labels 401 may have specific certain requirements, such as size, rotation, color contrast, and location within the ad.

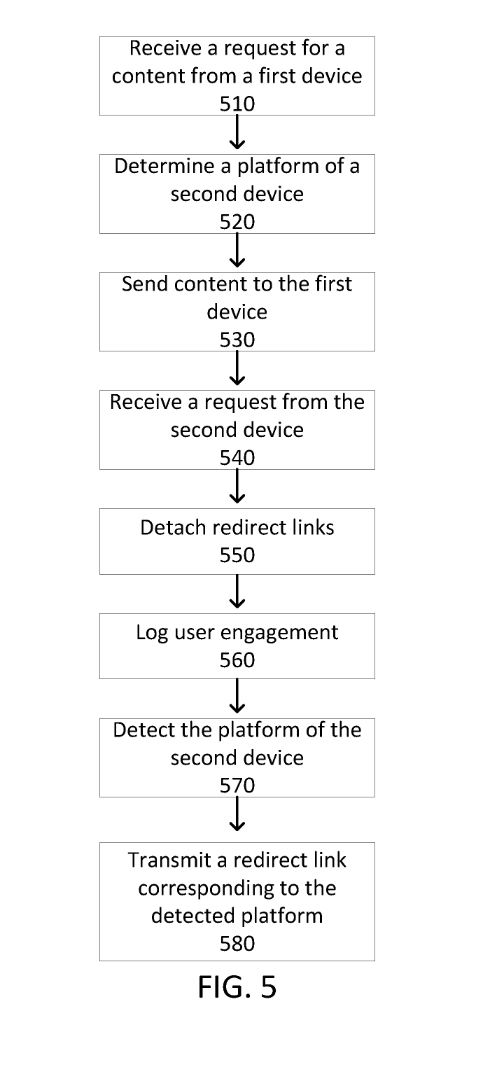

FIG. 5 is a flowchart of one embodiment of a method for serving content, logging user engagement, and transmitting a platform-specific redirect link. The method generally includes receiving a request for content from a first client device (ACT 510), determining a platform of a first client device (ACT 520), and sending the content to the second client device (ACT 530). The method further includes receiving a request from the second client device (ACT 540), detaching redirect links (ACT 550), and logging user engagement (ACT 560). The method further includes detecting the platform of the second client device (ACT 570), and transmitting the redirect link corresponding to the detected platform (ACT 580). In some implementations, the method may be performed in the content server and the click server that are part of the content item management service.

Specifically, the method includes receiving a request for content from a first client device (ACT 510). The request may be sent from a first client device after loading a webpage from a website publisher or other first-party content provider. The website publisher may redirect the first client device to a content item management system, which receives the request from the first client for an ad or a third-party content item. The requested content may be retrieved from a memory element of the content item management service. In other implementations, the first client device may send a request for the content as part of a mobile application or software.

The method may further include determining a platform of a second client device (ACT 520). The platform may be determined by examining the history, settings, and cookies of the second client device. In some implementations, the platform may be determined by examining the joint cookies that are shared across both the first and the second device. In some implementations, the platform may be determined by a user's interest.

The method may further include sending the content to the first client device (ACT 530). The content may be displayed at the first client device as part of a first-party content provider or webpage. The content may also be displayed within a mobile application. The user may then scan the label embedded in the content using a second client device, which decodes the combined URL in the label and sends a request to the click server. In some implementations, the label may store a shortened URL, and the second device may decode the shortened URL, send a request to a shortened URL server, and be redirected to the click server via a combined URL. The method then includes receiving a request from the second client device (ACT 540). The request may be sent from an internet browser, a mobile application, or other software executing on the second client device.

The method further includes detaching the redirect link (ACT 550) from the combined URL received as a request from the second client device. Other information that may have been combined to the combined URL may also be detached. For example, the combined URL may also include platform information corresponding to the redirect link, content item management service account information, or content identification.

The method further includes logging user engagement (ACT 550). The user engagement may be logged in a memory element within the click server or the content item management service. The logging may update one or more performance metric, such as those described earlier. In some implementations, the performance metrics may be updated by using the account information or content identification detached from the combined URL.

As shown in FIG. 5, the method further includes detecting the platform of the second client device (ACT 570). In some implementations, the platform of the second client device may be detected by cookies, settings, or history stored on the second client device, on the first client device, or on the content item management service. In some implementations, a client-side server script may be run on the second client device to detect the platform. In some implementations, a HTTP packet header field user-agent string may be examined to detect the platform of the second client device. In some implementations, if the platform of the second client device cannot be detected, the previously determined platform information from the first client device may be used.

The method further includes transmitting the redirect link corresponding to the detected platform (ACT 580). In some implementations, where the redirect page is for example a coupon or a promotion, the redirect link may not correspond to a detected platform. The second client device may receive the redirect link and browse to the redirect page.

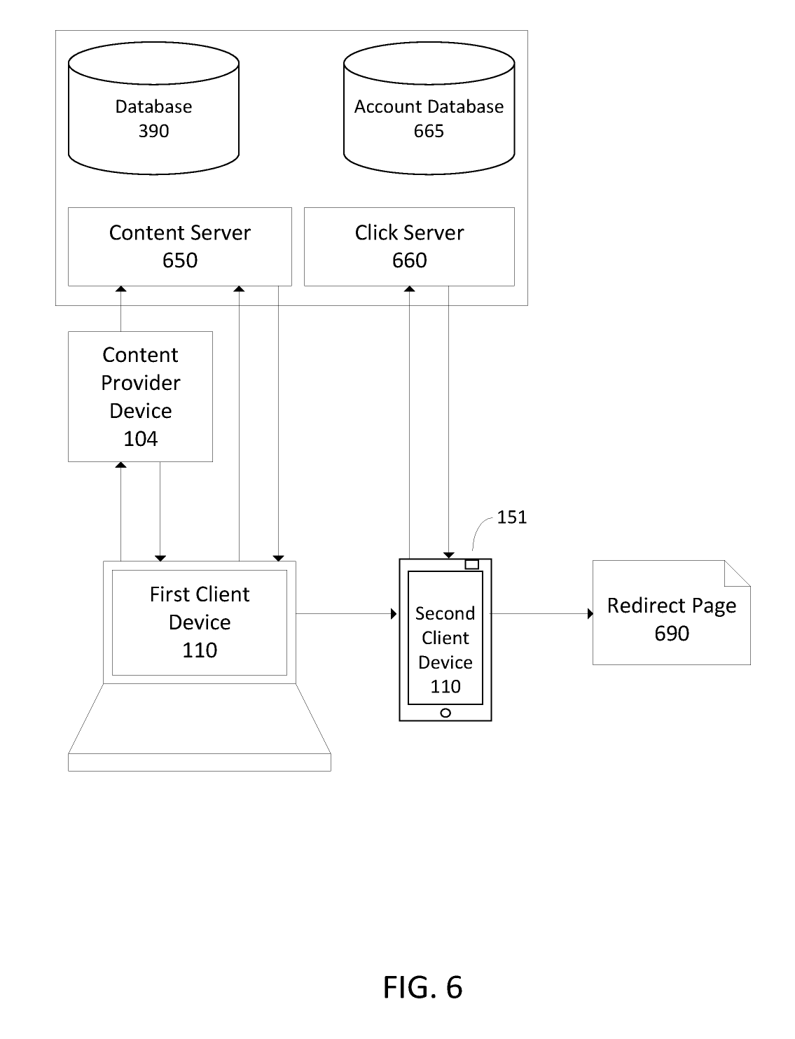

FIG. 6 is a diagram of one embodiment of a system for serving the content, logging user engagement and transmitting a platform-specific redirect link. The system generally comprises a content server 650, a database 390, a click server 660, and an account database 665. The system may communicate with a content provider computing device 104 (e.g. first-party content provider), first client device 110, and second client device 110. The system may also store the URL of a redirect page 690. The system described may be part of a content item management system. The content server 650 and the click server 660 can each be components of the data processing system 108.

A user, on a first client device 110, loads the webpage from a content provider computing device 104. The first client device 110 may be a desktop computer connected to a monitor, a laptop, a tablet, a smartphone, a smart watch, a set-top box for a television set, a smart television or any computing device with a display output and an internet browser. The content provider computing device 104 may communicate with the system which may select content to be presented on the web page. The selected content may be retrieved from database 390. The content server 650 may also obtain or modify third-party content provider account information or website publisher account information from account database 665. The third-party content provider account information may detail when, how frequently, and on what types of webpages to place the content. The website publisher account information may detail any types of restrictions or preferences for the types of content to place on its webpage.

The content provider computing device 104 returns the webpage or the first-party content to the first client device 110. The first client device 110, as part of loading the webpage, requests content from the content server 650. In response, the content server 650 obtains generated content from database 390. The content server 650 then sends content to the first client device 110.

In some implementations, content server 650 may also determine the platform for the second client device 110. Content server 650 may track the cookies on the first client device 110 to determine a platform of a second client device 110 used by the same user. Some of the cookies may be stored both on the second client device 110 and the first client device 110, the cookies corresponding to the user. The content server 650 may examine these joint cookies to determine the platform of the second client device 110, such as operating system. The content server 650 may also determine the operating system version and hardware specifications of the second client device 110. The content server 650 may also determine the platform of the second client device 110 by determining the user's interests by, for example, examining other cookies. In addition, the content server 650 may examine other settings and history of the first client device 110 to determine the platform of the second client device 110 or user interest. The platform may include, for example, a mobile operating system or an internet browser.

Once the content is loaded on the first client device 110, the user may use a second client device 110 to scan a label embedded in the ad. The second client device 110 may be a smart phone, a tablet, a laptop, or a desktop computer attached to a webcam or an image input device. The second client device 110 comprises a camera 151 that may capture an image of the label that is on the display of the first client device 110. The second client device 110 scans the label and decodes the combined URL.

The second client device 110 uses the combined URL to send a request to the click server 660. The click server 660 receives the request. The request may be a HTTP request. The click server 660 also detaches the URL of the redirect pages from the combined URL. Each of the detached redirect page URLs may correspond to different platforms. The click server 660 may also detach additional information that may have been attached to the combined URL as query strings.

The click server 660 may then log user engagement associated with the content in account database 665. In some implementations, content identification or the third-party content provider account information may be part of the combined URL. The click server 660 would detach the content identification or the third-party content provider account information and use it to access the account database 665. Once the user engagement is logged, it can be used by the content item management service to charge the service provider computing device 102 based on CPE, or any other measure of content performance described earlier.

The click server 660 detects the platform of the second client device 110. To detect the platform, the click server 660 may examine a user-agent string sent by the second client device 110 as part of the hypertext transport protocol (HTTP) header file. In some implementations, the click server 660 may examine the cookies stored on the second client device 110. It may also run a client-side script that detects the platform. The click server 660 may also access the memory element storing platform information determined by the content server 650. The platform information may also have been previously determined at the first client device 110.

Upon detection of the platform, the click server 660 sends the second client device 110 the redirect page URL that matches the platform of the second client device 110. The second client device 110, upon receiving the redirect page URL, browses to the redirect page. In some implementations, redirect pages 690 may be platform-specific app download pages. The user may then download and install the app on her second client device 110. In some implementations, redirect pages may point to promotions or coupons. The user may use the promotions or coupons in stores or save them in the first client device for later use.

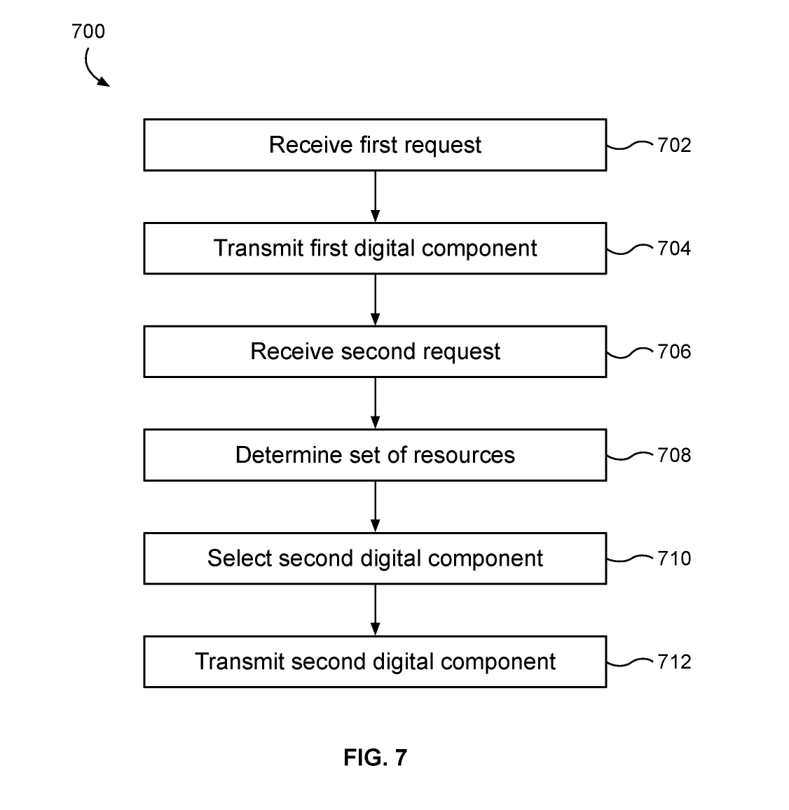

FIG. 7 illustrates a block diagram of an example method to complete network requests with multiple devices. The method 700 can include receiving a first request from a first computing device (ACT 702). The method 700 can include transmitting a first digital component to the first computing device (ACT 704). The method 700 can include receiving a second request from a second computing device (ACT 706). The method 700 can include determining a set of resources associated with the second computing device (ACT 708). The method 700 can include selecting a second digital component (ACT 710). The method 700 can include transmitting the second digital component to the second computing device (ACT 712).

The method 700 can include receiving a first request (ACT 702). The request can be received from a first computing device. The request can be an audio-based request that is recorded or otherwise detected at the first computing device. For example, the first computing device can include a sensor 151 to record or detect the audio-based request. The request can include video-based or text-based requests. The first computing device can include a camera. A user can capture an image or video with the camera, which the first computing device can transmit to the data processing system 108. The first computing device can transmit the request to the data processing system 108 as a plurality of data packets. The first computing device can transmit the request to the data processing system 108 as an input audio-signal (or input video-signal or input text-signal). The NPL component 160, executed by the data processing system 108, can receive the data packets via an interface. The data packets can be received via the network 106 as packet or other protocol based data transmissions. The NPL component 160 can identify, from the input audio signal, the request and trigger keywords that can correspond to the request. For example, the NLP component 160 can parse the input audio signal to identify requests that relate to subject matter of the input audio signal, or to identify trigger keywords that can indicate, for example, actions associated with the requests. For example, the request can be “OK, how do I get to restaurant XYZ.” The NPL component 160 can determine the trigger keywords are “get to.” The NPL component 160 can determine, based on the trigger keywords, the request is for directions to the restaurant XYZ.

The method 700 can include transmitting a first digital component to the first computing device (ACT 704). The digital component can include a label and audio-based content. The data processing system 108 can encode a URL into the label. The label can be an optical label (such as a QR code), a voiceprint label, or a videoprint label. The data processing system 108 can encode a click server uniform resource locator into the label. The URL can be a network location of additional or secondary digital components that are related to the first digital component. For example, if the first digital component includes a map image of the directions to a restaurant, the second digital component can include instructions that cause a map program to load driving directions to the restaurant.

In some implementations, the method 700 can generate at least one action data structure. For example, the direct action API 135 can generate action data structures based on the requests or trigger keywords that the NLP component 160 identified in the input audio signal. The action data structures can indicate organic or non-sponsored content related to the input audio signal. The method can select at least one digital component based on the action data structure. For example, the content selector component 125 can receive the request(s) or the trigger keyword(s) and based on this information can select one or more digital components. The digital components can include sponsored items having subject matter that relates to subject matter of the request or of the trigger keyword. The content items can be selected by the content selector component 125 via a real-time content selection process. The content selector component 125 can select multiple digital components based on the action data structure. The different digital components can use different computing device resource for their execution, display, or rendering. For example, a first digital component can be an audio-based digital component that includes audio-based content. Rendering of the audio-based digital component can require the computing device to include or be associated with a speaker via which the computing device can render the audio-based content. Another digital component can include pictures that require the computing device to include a screen for the display of the video-based content. In some implementations, the direct action API 135 can generate multiple action data structures. The different action data structures can be transmitted to different computing devices to fulfil the request. For the example request “OK, how do I get to restaurant XYZ,” the data processing system 108 can select an action data structure and digital components that provide directions from the current location of the first device to the restaurant XYZ. The digital component can include an audio-based filed that includes a computer generated voice speaking how to get to restaurant XYZ. The digital component could include an image of a map to the restaurant XYZ that is displayed by the data processing system 108 to a user.

The display, rending, or execution of the digital component can depend on the computing device having a specific set of resources. The set of resources can also include an identification of the components, applications, or resources of the computing device. For example, the set of resources can include an indication of whether the computing device includes a camera, video camera, microphone, sensor (e.g., a temperature sensor or accelerometer), a display screen, or whether specific applications are installed on the computing device. The set of resources can also include status information about the computing device. For example, the set of resource can include a battery status, processor utilization, screen resolution, memory utilization, an interface parameter, and network bandwidth utilization.

The interface management component 140 can poll different computing devices associated with the first computing device to determine a set of resources for each of the polled computing devices. The interface management computing 140 can select which computing devices to poll by identifying different computing devices that are associated with a same account as is associated with the first computing device. For example, a user may log into a service on each of his computing devices. The interface management component 140 can poll each of the computing devices into which the user logged in. Each of the computing devices associated with the first computing device can be referred to as candidate interfaces.

The interface management component 140 can select one of the candidate interfaces (e.g., one of the computing devices associated with the first computing device) as a second computing device. The interface management component 140 can select the candidate interface as the second computing device because the candidate interface includes a set of resources to need to display, render, or otherwise execute one of the digital components selected based on the action data structure. The digital component can require the use of a predetermined set of resources to be displayed, rendered, or executed. The data processing system 108 can select a URL based on the selected candidate interface (e.g., a second computing device). The URL can be a network location of a digital component. In some implementations, the data processing system 108 can select a plurality of different URLs. The different URLs can be network locations of different digital components for which a computing device would use different sets of resources for rendering, displaying, or executing. For example, a first URL can be a network location to an audio-based digital component (where a computing device may use speakers for the presentation of the digital component) and a second URL can be a network location to a video-based digital component (where a computing device may use a screen for the presentation of the digital component). The interface management component 140 can generate the different URLs without polling the candidate interfaces. For example, the interface management component 140 can generate a different URL that is configured for each of a different type of computing device the interface management component 140 predicts may interact with the digital component. The different URLs can be, or can be referred to as, redirect links. The data processing system 108 can generate different redirect links associated with different specific computing devices (e.g., the first and the second computing device) or different types of computing devices (e.g., computing devices having a first set of resources and computing devices having a second set of resources). In some implementations, the second computing device is not associated with the first computing device. For example, the first and second computing devices can be the computing devices of friends, but are not linked to one another through a common user account.

The method 700 can include receiving a request from the second computing device (ACT 706). The request from the second computing device can include the URL that was encoded in the label of the first digital component. For example, based on the input audio file “OK, how do I get to restaurant XYZ,” the data processing system 108 can generate a first action data structure that includes a map of the directions to the restaurant XYZ. The digital component can also include a label that the first computing device can present to the second computing device. For example, the label can be a barcode that is presented on a screen of the first computing device. The second computing device can scan the barcode with a camera. The label can be a voiceprint label that when processed by the first computing device cause the speaker 154 to generate audible or sub-audible (to humans) sound waves. The second computing device can detect the sound waves with a transducer 152. The second computing device can process the received label and identify the URL. The second computing device can then generate and transmit a request to the data processing system 108 that includes the URL. In some implementations, the request the second computing device transmits to the data processing system 108 can include an indication of the resources of the second computing device.

The method 700 can include determining a set of resources associated with the second computing device (ACT 708). The data processing system 108 can determine the set of resources associated with the second computing device detecting cookies, settings, or history stored on the second computing device, on the first computing device, or provided to the data processing system 108. For example, the second request sent from the second computing device to the data processing system 108 can include or indicate a set of resources associated with the second computing device. In some implementations, the set of resources associated with the second computing device can be determined after the data processing system 108 receives the second request or the interface management computing can determine the set of resources prior to the receipt of the second request. The data processing system 108 can determine whether the set of resources associated with the second computing device is the same or different than the set of resources associated with the first computing device.

The method 700 can include selecting a second digital component based on the URL and the second computing device's set of resources (ACT 710). The digital component can be selected based on the set of resources associated with the second computing device. The digital component can be selected based on the URL. For example, the data processing system 108 can identify different redirect links. Each of the different redirect links can be associated with different sets of resources. The data processing system 108 can select a redirect link based on the second computing device's set of resources. In some implementations, the redirect link can be a component of the digital component. The data processing system 108 can select a second action data structure that includes the selected digital component. In some implementations, the data processing system 108 can convert the second digital component for delivery into a modality compatible with the second computing device. For example, if the data processing system 108 determines, the second computing device does not include a screen, but the digital component includes audio and video based content, the data processing system 108 can convert the digital component into an audio-only digital component.

The method 700 can include transmitting the second digital component to the second computing device (ACT 712). The data processing system 108 can transmit an action data structure to the second computing device. Continuing the above example, where the initial request can include the input audio-signal “Ok, how do I get to restaurant XYZ,” a first digital component can be sent to the first computing device, which can be a speaker device with a screen. The first computing device can display first digital component, which can include a map of the directions and a label. The label can be a barcode. The user, or another party, can scan the label with the camera of a second computing device. Responsive to scanning the label, the second computing device can transmit a second request to the data processing system 108. The data processing system 108 can transmit a second digital component to the second computing device in response to receiving the second request. The second digital component can include the map of driving instructions or a script that causes a map application on the second computing device to open and load the driving directions to the restaurant XYZ.

For situations in which the systems discussed herein collect personal information about users, or may make use of personal information, the users may be provided with an opportunity to control whether programs or features that may collect personal information (e.g., information about a user's social network, social actions or activities, a user's preferences, or a user's location), or to control whether or how to receive content from a content server or other data processing system that may be more relevant to the user. In addition, certain data may be anonymized in one or more ways before it is stored or used, so that personally identifiable information is removed when generating parameters. For example, a user's identity may be anonymized so that no personally identifiable information can be determined for the user, or a user's geographic location may be generalized where location information is obtained (such as to a city, postal code, or state level), so that a particular location of a user cannot be determined. Thus, the user may have control over how information is collected about him or her and used by the content server.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “data processing system” “computing device” “component” or “data processing apparatus” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The interface management component 140, direct action API 135, content selector component 125, prediction component 120 or NLP component 160 and data processing system 108 components can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 108) to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or a combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 can include clients and servers. A client and server are generally remote from each other and typically interact through a communication network (e.g., the network 106). The relationship of client and server arises by virtue of computer programs running on the respective computers and having a client-server relationship to each other. In some implementations, a server transmits data (e.g., data packets representing action data structures or content items) to a client device (e.g., to the client computing device 110 for purposes of displaying data to and receiving user input from a user interacting with the client device, or to the service provider computing device 102 or the content provider computing device 104). Data generated at the client device (e.g., a result of the user interaction) can be received from the client device at the server (e.g., received by the data processing system 108 from the computing device 110 or the content provider computing device 104 or the service provider computing device 102).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, the NLP component 160, the content selector component 125, the interface management component 140, or the prediction component 120 can be a single component, app, or program, or a logic device having one or more processing circuits, or part of one or more servers of the data processing system 108.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1.-20. (canceled)

21. A system to complete requests with multiple networked devices, comprising a data processing system to:
receive a first request for content from a first computing device;
transmit a digital component to the first computing device to fulfill the first request, the digital component comprising a label and audio-based content, the label encoding a uniform resource locator;
receive a second request from a second computing device, the second request comprising the uniform resource locator and the second request generated responsive to the second computing device decoding the label;
determine a set of resources associated with the second computing device;
select a second digital component based on the uniform resource locator and the set of resources; and
transmit the second digital component to the second computing device.

22. The system of claim 21, wherein the label comprises one of a Quick Response (QR) code, optical label, a voiceprint label, or a videoprint label.

23. The system of claim 21, comprising an encoding engine to:
encode a click server uniform resource locator into the label; and
encode a first redirect link associated with the first computing device and a second redirect link associated with the second computing device into the label.

24. The system of claim 23, comprising an interface management component to:
determine the set of resources is different than a set of resources associated with the first computing device; and
select the second digital component based on the second redirect link.

25. The system of claim 23, comprising an interface management comprising to:
determine the set of resources is the same as a set of resources associated with the first computing device; and
select the second digital component based on the first redirect link.

26. The system of claim 21, comprising a natural language processing component to:
receive, via an interface of the data processing system, data packets comprising an input audio signal detected by a sensor of the first computing device; and
identify, from the input audio signal, the first request and a trigger keyword corresponding to the first request.

27. The system of claim 21, comprising an interface management component to:
identify the second computing device as a candidate interface; and
select the uniform resource locator based on the second computing device.

28. The system of claim 21, comprising:
an interface management component to convert the second digital component for delivery in a modality compatible with the second computing device.

29. The system of claim 21, comprising:
a direct action application programming interface to generate, based on a trigger keyword in the first request, a first action data structure and a second action data structure.

30. The system of claim 29, comprising an interface management component to:
transmit the first action data structure to the first computing device; and
transmit the second action data structure to the second computing device.

31. A method to complete requests with multiple networked devices, comprising:
receiving, by a data processing system, a first request for content from a first computing device;
transmitting, by the data processing system, a digital component to the first computing device to fulfill the first request, the digital component comprising a label and audio-based content, the label encoding a uniform resource locator;
receiving, by the data processing system, a second request from a second computing device, the second request comprising the uniform resource locator and the second request generated responsive to the second computing device decoding the label;
determining, by the data processing system, a set of resources associated with the second computing device;
selecting, by the data processing system, a second digital component based on the uniform resource locator and the set of resources; and
transmitting, by the data processing system, the second digital component to the second computing device.

32. The method of claim 31, wherein the label comprises one of a Quick Response (QR) code, optical label, a voiceprint label, or a videoprint label.

33. The method of claim 31, comprising:
encoding, by the data processing system, a click server uniform resource locator into the label; and
encoding, by the data processing system, a first redirect link associated with the first computing device and a second redirect link associated with the second computing device into the label.

34. The method of claim 33, comprising:
determining, by the data processing system, the set of resources is different than a set of resources associated with the first computing device; and
selecting, by the data processing system, the second digital component based on the second redirect link.

35. The method of claim 33, comprising:
determining, by the data processing system, the set of resources is the same as a set of resources associated with the first computing device; and
selecting, by the data processing system, the second digital component based on the first redirect link.

36. The method of claim 31, comprising:
receiving, by a natural language processor component executed by the data processing system, via an interface of the data processing system, data packets comprising an input audio signal detected by a sensor of the first computing device; and
identifying, by the natural language processor component, from the input audio signal, the first request and a trigger keyword corresponding to the first request.

37. The method of claim 31, comprising:
polling, by an interface management component of the data processing system, to identify the second computing device as a candidate interface; and
selecting, by the data processing system, the uniform resource locator based on the second computing device.

38. The method of claim 31, comprising:
converting, by the data processing system, the second digital component for delivery in a modality compatible with the second computing device.

39. The method of claim 31, comprising:
generating, by a direct action application programming interface of the data processing system and based on a trigger keyword in the first request, a first action data structure and a second action data structure.

40. The method of claim 39, comprising:
transmitting, by the data processing system, the first action data structure to the first computing device; and
transmitting, by the data processing system, the second action data structure to the second computing device.
